(19) United States
(12) Patent Application Publication
(10) Pub. No.: US 2020/0410980 A1
(43) Pub. Date: Dec. 31, 2020

(54) INTERACTIVE ELECTRONIC APPARATUS, COMMUNICATION SYSTEM, METHOD, AND PROGRAM

(71) Applicant: KYOCERA Corporation, Kyoto (JP)

(72) Inventors: Yuki YAMADA, Yokohama-shi, Kanagawa (JP); Hiroshi OKAMOTO, Yokohama-shi, Kanagawa (JP); Joji YOSHIKAWA, Sagamihara-shi, Kanagawa (JP)

(73) Assignee: KYOCERA Corporation, Kyoto (JP)

(21) Appl. No.: 16/638,635

(22) PCT Filed: Aug. 1, 2018
(86) PCT No.: PCT/JP2018/028889

§ 371 Date: Feb. 12, 2020

(30) Foreign Application Priority Data
Aug. 17, 2017 (JP) 2017-157647
Aug. 25, 2017 (JP) 2017-162397

(51) Int. Cl. G10L 13/08; G10L 15/22; G10L 17/22; G06F 3/16

(52) U.S. Cl. CPC G10L 13/08; G06F 3/16; G10L 17/22; G10L 15/22

(57) ABSTRACT

An interactive electronic apparatus includes a controller. The controller is configured to acquire a privacy level corresponding to a person located in the vicinity of the interactive electronic apparatus. The controller performs a content modification operation for modifying the content to be verbally output from a speaker, based on the privacy level. The interactive electronic apparatus may be configured as a mobile terminal. The controller may perform the content modification operation when the interactive electronic apparatus is mounted on a charging stand.

### CROSS REFERENCE TO RELATED APPLICATIONS

This application claims priority to and the benefit of Japanese Patent Applications No. 2017-157647 filed on Aug. 17, 2017 and No. 2017-162397 filed on Aug. 25, 2017, the entire contents of which are incorporated herein by reference.

### TECHNICAL FIELD

The present disclosure relates to an interactive electronic apparatus, a communication system, a method, and a program.

### BACKGROUND

Mobile terminals such as smartphones, tablet PCs, and laptop computers are in widespread use. Mobile terminals utilize electric power stored in built-in batteries to operate. Mobile terminal batteries are charged by charging stands that supply electric power to a mobile terminal mounted thereon.

For the charging stands, improved charging functionality (see PTL 1), downsizing (see PTL 2), and simplified configurations (see PTL 3) have been proposed.

### CITATION LIST

### Patent Literature

PTL 1: JP-A-2014-217116

PTL 2: JP-A-2015-109764

PTL 3: JP-A-2014-079088

### SUMMARY

An interactive electronic apparatus according to a first aspect of the present disclosure includes:

a controller configured to perform a content modification operation for modifying a content to be verbally output from a speaker, based on a privacy level corresponding to a person located in the vicinity of the interactive electronic apparatus.

A communication system according to a second aspect of the present disclosure includes:

a mobile terminal; and

a charging stand on which the mobile terminal can be mounted, wherein one of the mobile terminal and the charging stand modifies a content to be verbally output from a speaker, based on a privacy level corresponding to a person located in the vicinity of the one of the mobile terminal and the charging stand.

A method according to a third aspect of the present disclosure includes:

a step of modifying a content to be verbally output from a speaker, based on a privacy level corresponding to a person located in the vicinity of an apparatus.

A program according to a fourth aspect of the present disclosure for causing an interactive electronic apparatus to modify a content to be verbally output from a speaker, based on a privacy level corresponding to a person located in the vicinity of the interactive electronic apparatus.

An interactive electronic apparatus according to a fifth aspect of the present disclosure includes a controller configured to perform a speech operation using a content corresponding to a specific level of a user targeted for interaction.

A communication system according to a sixth aspect of the present disclosure includes:

a mobile terminal; and

a charging stand on which the mobile terminal can be mounted,

wherein one of the mobile terminal and the charging stand performs a speech operation using a content corresponding to a specific level of a user targeted for interaction.

A method according to a seventh aspect of the present disclosure includes:

a step of determining a specific level of a user targeted for interaction; and

a step of performing a speech operation using a content corresponding to the specific level.

A program according to an eighth aspect of the present disclosure for causing an interactive electronic apparatus to perform a speech operation using a content corresponding to a specific level of a user targeted for interaction.

### BRIEF DESCRIPTION OF THE DRAWINGS

In the accompanying drawings:

FIG. 1 is an elevation view illustrating an exterior of a communication system that includes an interactive electronic apparatus according to an embodiment;

FIG. 2 is a side view of the communication system of FIG. 1;

FIG. 3 is a functional block diagram schematically illustrating the internal configurations of a mobile terminal and the charging stand of FIG. 1;

FIG. 4 is a flowchart illustrating an initial setting operation performed by a controller of the mobile terminal according to a first embodiment;

FIG. 5 is a flowchart illustrating a privacy setting operation performed by the controller of the mobile terminal according to the first embodiment;

FIG. 6 is a flowchart illustrating a speech execution determination operation performed by a controller of the charging stand according to the first embodiment;

FIG. 7 is a flowchart illustrating a privacy level recognition operation performed by the controller of the mobile terminal according to the first embodiment;

FIG. 8 is a flowchart illustrating a content modification operation performed by the controller of the mobile terminal according to the first embodiment;

FIG. 9 is a flowchart illustrating a schedule notification subroutine executed by the controller of the mobile terminal according to the first embodiment;

FIG. 10 is a flowchart illustrating a note notification subroutine executed by the controller of the mobile terminal according to the first embodiment;

FIG. 11 is a flowchart illustrating an e-mail notification subroutine executed by the controller of the mobile terminal according to the first embodiment;

FIG. 12 is a flowchart illustrating an incoming call notification subroutine executed by the controller of the mobile terminal according to the first embodiment;

FIG. 13 is a flowchart illustrating a location determination operation performed by the controller of the charging stand according to a second embodiment;

FIG. 14 is a flowchart illustrating a speech execution determination operation performed by the controller of the charging stand according to the second embodiment;

FIG. 15 is a flowchart illustrating a specific level recognition operation performed by the controller of the mobile terminal according to the second embodiment;

FIG. 16 is a flowchart illustrating a location determination operation performed by the controller of the mobile terminal according to the second embodiment;

FIG. 17 is a flowchart illustrating an entrance hall interaction subroutine performed by the controller of the mobile terminal according to the second embodiment;

FIG. 18 is a flowchart illustrating a dining table interaction subroutine performed by the controller of the mobile terminal according to the second embodiment;

FIG. 19 is a flowchart illustrating a child room interaction subroutine performed by the controller of the mobile terminal according to the second embodiment;

FIG. 20 is a bedroom interaction subroutine executed by the controller of the mobile terminal according to the second embodiment;

FIG. 21 is a flowchart illustrating a message operation performed by the controller of the charging stand according to the second embodiment; and

FIG. 22 is a flowchart illustrating a messaging operation performed by the controller of the charging stand according to the second embodiment.

### DETAILED DESCRIPTION

Hereinafter, embodiments of the present disclosure will be described with reference to the accompanying drawings.

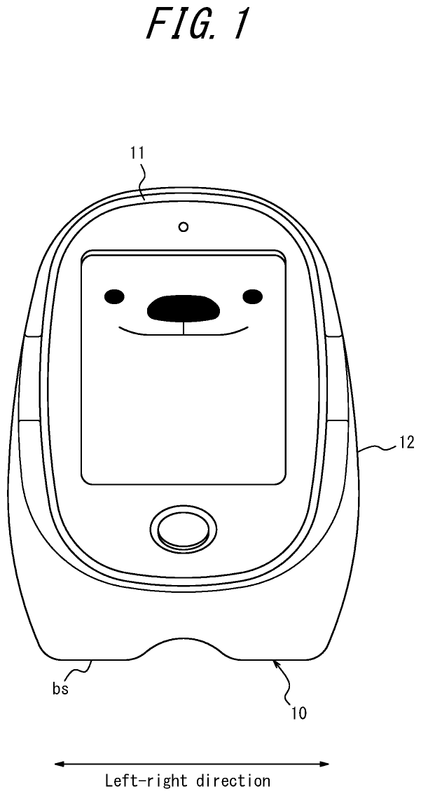

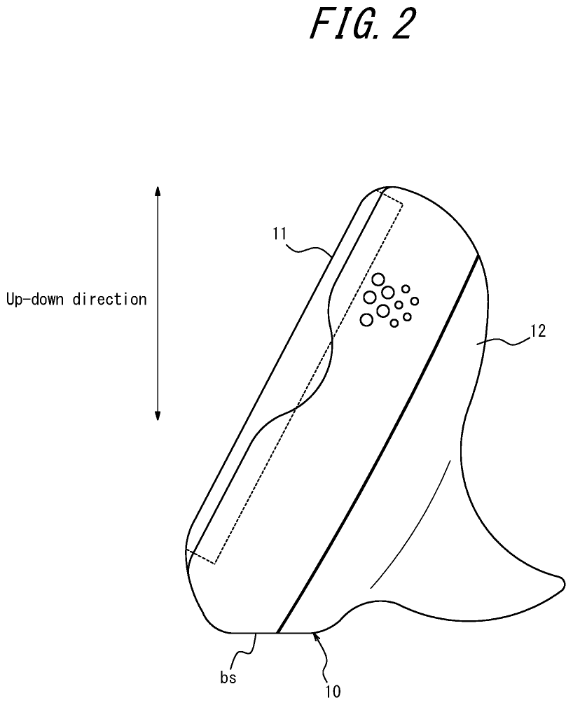

According to a first embodiment of the present disclosure, a communication system 10 includes a mobile terminal 11 configured as an interactive electronic apparatus, and a charging stand 12, as illustrated in FIG. 1 and FIG. 2. The mobile terminal 11 can be mounted on the charging stand 12. When the mobile terminal 11 is mounted on the charging stand 12, the charging stand 12 charges an internal battery of the mobile terminal 11. Also, when the mobile terminal 11 is mounted on the charging stand 12, the communication system 10 can interact with a user. At least one of the mobile terminal 11 and the charging stand 12 has a messaging function and notifies a message for a specific user to the corresponding user.

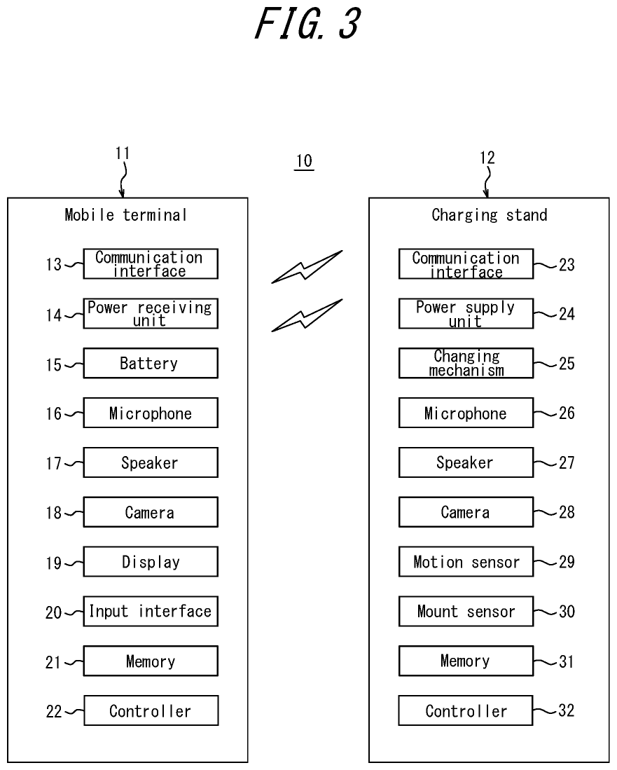

The mobile terminal 11 includes a communication interface 13, a power receiving unit 14, a battery 15, a microphone 16, a speaker 17, a camera 18, a display 19, an input interface 20, a memory 21, and a controller 22, as illustrated in FIG. 3.

The communication interface 13 includes a communication interface capable of performing communication using voice, characters, or images. As used in the present disclosure, “communication interface” may encompass, for example, a physical connector, a wireless communication device, or the like. The physical connector may include an electrical connector which supports transmission of electrical signals, an optical connector which supports transmission of optical signals, or an electromagnetic connector which supports transmission of electromagnetic waves. The electrical connector may include connectors compliant with IEC60603, connectors compliant with the USB standard, connectors corresponding to an RCA pin connector, connectors corresponding to an S terminal as defined in EIAJ CP-1211A, connectors corresponding to a D terminal as defined in EIAJ RC-5237, connector compliant with HDMI® (HDMI is a registered trademark in Japan, other countries, or both), connectors corresponding to a coaxial cable including BNC (British Naval Connector), Baby-series N Connector, or the like. The optical connector may include a variety of connectors compliant with IEC 61754. The wireless communication device may include devices conforming to various standards such as Bluetooth® (Bluetooth is a registered trademark in Japan, other countries, or both) or IEEE 802.11. The wireless communication device includes at least one antenna.

The communication interface 13 communicates with an external device that is external to the mobile terminal 11 such as, for example, the charging stand 12. The communication interface 13 communicates with the external device by performing wired or wireless communication. In a configuration in which the communication interface 13 performs wired communication with the charging stand 12, the mobile terminal 11 mounted on the charging stand 12 in an appropriate orientation at an appropriate position is connected to a communication interface 23 of the charging stand 12 and can communicate therewith. The communication interface 13 may communicate with the external device in a direct manner using wireless communication or in an indirect manner using, for example, a base station and the Internet or a telephone line.

The power receiving unit 14 receives electric power supplied from the charging stand 12. The power receiving unit 14 includes, for example, a connector for receiving electric power from the charging stand 12 via a wire. Alternatively, the power receiving unit 14 includes, for example, a coil for receiving electric power from the charging stand 12 using a wireless feeding method such as an electromagnetic induction method or a magnetic field resonance method. The power receiving unit 14 charges the battery 15 with the received electric power.

The battery 15 stores electric power supplied from the power receiving unit 14. The battery 15 discharges electric power and thus supplies electric power necessary for constituent elements of the mobile terminal 11 to execute the respective functions.

The microphone 16 detects a voice originating in the vicinity of the mobile terminal 11 and converts the voice into an electrical signal. The microphone 16 outputs the detected voice to the controller 22.

The speaker 17 outputs a voice based on the control by the controller 22. For example, when the speaker 17 performs a speech function, which will be described below, the speaker 17 outputs speech determined by the controller 22. For example, when the speaker 17 performs a call function with another mobile terminal, the speaker 17 outputs a voice acquired from the another mobile terminal.

The camera 18 captures an image of a subject located in an imaging range. The camera 18 can capture both a still image and a video image. When capturing a video image, the camera 18 successively captures images of a subject at a speed of, for example, 60 fps. The camera 18 outputs the captured images to the controller 22.

The display 19 is configured as, for example, a liquid crystal display (LCD), an organic EL (Electroluminescent) display, or an inorganic EL display. The display 19 displays an image based on the control by the controller 22.

The input interface 20 is configured as, for example, a touch panel integrated with the display 19. The input interface 20 detects various requests or information associated with the mobile terminal 11 input by the user. The input interface 20 outputs a detected input to the controller 22.

The memory 21 may be configured as, for example, a semiconductor memory, a magnetic memory, an optical memory, or the like. The memory 21 stores, for example, various information necessary for the execution of a registration operation, a content modification operation, a speech operation, a voice recognition operation, a watching operation, a data communication operation, a telephone call operation, or the like, which will be described later. The memory 21 also stores an image of the user, user information, an installation location of the charging stand 12, external information, the contents of conversations, a behavior history, local information, a specific target of the watching operation, or the like acquired by the controller 22 during the operations set forth above.

The controller 22 includes one or more processors. The controller 22 may include one or more memories for storing programs and information being calculated for use in various operations. The memory includes a volatile memory or a nonvolatile memory. The memory includes a memory independent of the processor or a built-in memory of the processor. The processor includes a general purpose processor configured to read a specific program and perform a specific function, or a specialized processor dedicated for specific processing. The specialized processor includes an application specific application specific integrated circuit (ASIC). The processor includes a programmable logic device (PLD). The PLD includes a field-programmable gate array (FPGA). The controller 22 may be configured as a system on a chip (SoC) or a system in a package (SiP), in which one or more processers cooperate.

For example, when the controller 22 receives an instruction from the charging stand 12 to transition to a communication mode as will be described later, the controller 22 controls each constituent element of the mobile terminal 11 to execute various functions for the communication mode. The communication mode is a mode of the communication system 10, constituted by the mobile terminal 11 and the charging stand 12, which causes execution of an interaction with a user targeted for interaction amongst specific users, observation of the specific users, sending messages to the specific users, and the like.

The controller 22 performs a registration operation for registering a user which executes the communication mode. For example, the controller 22 starts the registration operation upon detection of an input that requires user registration and is made in respect to the input interface 20.

For example, in the registration operation, the controller 22 issues a message instructing the user to look at a lens of the camera 18, and then captures an image of the user's face by activating the camera 18. Further, the controller 22 stores the captured image in association with user information including the name and attributes of the user. The attribute includes, for example, the name of the owner of the mobile terminal 11, the relationship or association of the user to the owner, gender, age bracket, height, weight, and the like. Relationships include, for example, family members of the owner of the mobile terminal 11 such as a parent, a child, a sibling, or the like. The association indicate the degree of interaction with the owner of the mobile terminal 11 such as an acquaintance, a close friend, a classmate, a work mate, and the like. The controller 22 acquires the user information input to the input interface 20 by the user.

In the registration operation, the controller 22 transfers a registered image together with the user information associated therewith to the charging stand 12. To do so, the controller 22 determines whether the controller 22 can communicate with the mobile terminal 11.

In a case in which the controller 22 cannot communicate with the charging stand 12, the controller 22 displays a message for enabling communication on the display 19. For example, when the mobile terminal 11 and the charging stand 12 are not connected to each other in a configuration in which the mobile terminal 11 and the charging stand 12 perform wired communication, the controller 22 displays a message requesting connection on the display 19. In a case in which the mobile terminal 11 and the charging stand 12 are located remote from each other and cannot communicate with each other in a configuration in which the mobile terminal 11 and the charging stand 12 perform wireless communication, the controller 22 displays a message requesting to approach the charging stand 12 on the display 19.

When the mobile terminal 11 and the charging stand 12 can communicate with each other, the controller 22 causes the mobile terminal 11 to transfer the registered image and the user information to the charging stand 12 and display an indication indicating that the transfer is in progress on the display 19. When the controller 22 acquires a transfer completion notification from the charging stand 12, the controller 22 causes the display 19 to display a message indicating that the initial setting has been completed.

When the communication system 10 is in transition to the communication mode, the controller 22 causes the communication system 10 to interact with a specific user by performing at least one of the speech operation and the voice recognition operation. The specific user is the user registered in the registration operation and, for example, the owner of the mobile terminal 11. In the speech operation, the controller 22 verbally outputs various information associated with the specific user from the speaker 17. The various information includes, for example, the content of a schedule, the content of a note, a sender of e-mail, a title of e-mail, a caller of an incoming call, and the like.

In the speech operation performed by the controller 22, the content of a notification is modified based on a privacy level. The privacy level is a degree indicating the extent to which personal information (information that identifies the user targeted for interaction) can be included in the content of a speech to the user targeted for interaction. The privacy level is set according to a person located in the vicinity of the mobile terminal 11. The privacy level may vary depending on a relationship or friendship of the person located in the vicinity of the mobile terminal 11 with the user targeted for interaction. The privacy level includes a first level corresponding to a case in which, for example, there is a person (e.g., a stranger) in the vicinity of the mobile terminal 11 who does not have a close relationship with the user targeted for interaction. The privacy level also includes a second level corresponding to a case in which, for example, people located in the vicinity of the mobile terminal 11 are the user targeted for interaction and a person who has a close relation with the user targeted for interaction (e.g., a family member or a close friend). The privacy level further includes a third level corresponding to a case in which, for example, only the user targeted for interaction is located in the vicinity of the mobile terminal 11.

For example, the content of a notification at the first level of the privacy level does not include personal information at all, or includes the content which is authorized for disclosure to unspecific users. For example, the content of a notification at the first level regarding a schedule to be verbally output is “There is a scheduled plan today.” For example, the content of a notification at the first level regarding a note to be verbally output is “There is a note.” For example, the content of a notification at the first level regarding e-mail to be verbally output is “You've got e-mail.” For example, the content of a notification regarding an incoming call at the first level to be verbally output is “There was an incoming call.”

The content of a notification at the second level or the third level of the privacy level (hereinafter, referred to as “the content of a speech at the second or third level”) is the content that includes personal information or the content which is authorized for disclosure to the user targeted for interaction. For example, the content of a notification at the second or third level regarding a schedule to be verbally output is “There is a welcome/farewell party scheduled at 7 pm today.” For example, the content of a notification at the second or third level regarding a note to be verbally output is “Report Y must be submitted tomorrow.” For example, the content of a notification at the second or third level regarding e-mail to be verbally output is “There is e-mail regarding Z from Mr. A.” For example, the content of a notification at the second or third level regarding an incoming call to be verbally output is “There was an incoming call from Mr. A.”

Here, the user can set the content to be disclosed at each of the first to third levels, using the input interface 20. For example, the user can set whether to authorize a verbal notification for each of a schedule, a note, received e-mail, an incoming call, and the like. Also, the user can set whether to authorize a verbal output of each of the content of a schedule, the content of a note, a sender of e-mail, a name of a caller, and the like. For example, the user can set whether to modify each of the content of a schedule, the content of a note, a sender of e-mail, a title of e-mail, a caller, and the like, based on the privacy level. Further, the user can set people to which information can be disclosed at the second level, based on, for example, the relationship or the association. The setting details (hereinafter, referred to as “setting information”) are stored in, for example, the memory 21, and synchronized by and shared with the charging stand 12.

In the speech operation, the controller 22 determines the content of a notification based on current time, location of the charging stand 12, a user targeted for interaction specified by the charging stand 12 as will be described later, e-mail or an incoming call received by the mobile terminal 11, a note and a schedule registered to the mobile terminal 11, voice of the user, and the contents of past conversations by the user. The controller 22 drives the speaker 17 to verbally output the determined content. Here, the controller 22 acquires the privacy level from the charging stand 12 in order to perform the speech operation. When a notification to be output is based on predetermined information, the controller 22 performs the content modification operation for modifying the content to be verbally output from the speaker 17, based on the privacy level. In the first embodiment, the predetermined information includes a schedule, a note, e-mail, and a telephone call. The controller 22 determines whether the content to be verbally output are to be subjected to the content modification operation, based on the setting information mentioned above. The controller 22 performs the content modification operation on the content.

The controller 22 determines whether the mobile terminal 11 is mounted on the charging stand 12 or removed from the charging stand 12, in order to determine the content to be verbally output. The controller 22 determines whether the mobile terminal 11 is mounted on the charging stand 12 or removed from the charging stand 12, based on a mounting notification acquired from the charging stand 12. For example, while the controller 22 receives mounting notifications from the charging stand 12 indicating that the mobile terminal 12 is mounted, the controller 22 determines that the mobile terminal 12 is mounted on the charging stand 12. Also, when the controller 22 stops receiving the mounting notifications, the controller 22 determines that the mobile terminal 11 is removed from the charging stand 12. Alternatively, the controller 22 may determine whether the mobile terminal 11 is mounted on the charging stand 12 or removed from the charging stand 12, based on whether the power receiving unit 14 can receive electrical power from the charging stand 12, or whether the communication interface 13 can communicate with the charging stand 12.

In the voice recognition operation, the controller 22 recognizes the content spoken by the user by performing morphological analysis of a voice detected by the microphone 16. The controller 22 performs a predetermined operation based on the recognized content. The predetermined operation may include, for example, a speech operation on the recognized content as described above, search for desired information, display of a desired image, or making a telephone call or sending e-mail to an intended addressee.

While the communication system 10 is in transition to the communication mode, the controller 22 stores the continuously performed speech operation and voice recognition operation described above in the memory 21 and learns the contents of conversations associated with the specified user targeted for interaction. The controller 22 utilizes the learned contents of the conversations to determine the content for later speech. The controller 22 may transfer the learned contents of conversations to the charging stand 12.

Further, when the communication system 10 is in transition to the communication mode, the controller 22 detects the current location of the mobile terminal 11. Detection of the current location is based on, for example, an installation location of a base station during communication or the GPS incorporated in the mobile terminal 11. The controller 22 notifies the user of local information associated with the detected current location. The notification of the local information may be generated as speech by the speaker 17 or an image displayed on the display 19. The local information may include, for example, sale information for a neighborhood store.

When the input interface 20 detects a request for starting the watching operation associated with a specific target while the communication system 10 is in transition to the communication mode, the controller 22 notifies the charging stand 12 of the request. The specific target may be, for example, a specific registered user, a room in which the charging stand 12 is located, or the like.

The watching operation is performed by the charging stand 12, regardless of whether or not the mobile terminal 11 is mounted on the charging stand 12. When the controller 22 receives a notification from the charging stand 12 indicating that the specific target is in an abnormal state that is performing the watching operation, the controller 22 notifies the user to that effect. The notification issued to the user may be generated as voice via the speaker 17 or as a warning image displayed on the display 19.

The controller 22 performs a data communication operation to send/receive e-mail or display an image using a browser, or perform a telephone call operation, based on an input to the input interface 20, regardless of whether the communication system 10 is in transition to the communication mode.

The charging stand 12 includes a communication interface 23, a power supply unit 24, a changing mechanism 25, a microphone 26, a speaker 27, a camera 28, a motion sensor 29, a mount sensor 30, a memory 31, a controller 32, and the like.

The communication interface 23 includes a communication interface capable of performing communication using voice, characters, or images, in a manner similar to the communication interface 13 of the mobile terminal 11. The communication interface 23 communicates with the mobile terminal 11 by performing wired or wireless communication. The communication interface 23 may communicate with an external device by performing wired communication or wireless communication.

The power supply unit 24 supplies electric power to the power receiving unit 14 of the mobile terminal 11 mounted on the charging stand 12. The power supply unit 24 supplies electric power to the power receiving unit 14 in a wired or wireless manner, as described above.

The changing mechanism 25 changes an orientation of the mobile terminal 11 mounted on the charging stand 12. The changing mechanism 25 can change the orientation of the mobile terminal 11 along at least one of the vertical direction and the horizontal direction that are defined with respect to a bottom surface bs (see FIGS. 1 and 2), which is defined with respect to the charging stand 12. The changing mechanism 25 includes a built-in motor and changes the orientation of the mobile terminal 11 by driving the motor. Alternatively, the changing mechanism 25 may include a rotary function (e.g., for rotation of 360 degrees) and may capture images of surroundings of the charging stand 12 using the camera 18 of the mobile terminal 11 mounted on the charging stand 12.

The microphone 26 detects voice originating in the vicinity of the charging stand 12 and converts the voice into an electrical signal. The microphone 26 outputs the detected voice to the controller 32.

The speaker 27 outputs voice based on the control by the controller 32.

The camera 28 captures a subject located within an imaging range. The camera 28 includes a direction changing device (e.g., a rotary mechanism) and can capture images of surroundings of the charging stand 12. The camera 28 can capture both a still image and a video image. When capturing a video image, the camera 28 successively captures a subject at a speed of, for example, 60 fps. The camera 28 outputs a captured image to the controller 32.

The motion sensor 29 is configured as, for example, an infrared sensor and detects the presence of a person around the charging stand 12 by detecting heat. When the motion sensor 29 detects the presence of a person, the motion sensor 29 notifies the controller 32 to that effect. Note that the motion sensor 29 may be configured as a sensor other than the infrared sensor such as, for example, an ultrasonic sensor. The motion sensor 29 may cause the camera 28 to detect the presence of a person based on a change in images continuously captured. The motion sensor 29 may be configured to cause the microphone 26 to detect the presence of a person based on detected voice.

The mount sensor 30 of the charging stand 12 is arranged on, for example, a mounting surface for mounting the mobile terminal 11 and detects the presence or absence of the mobile terminal 11. The mount sensor 30 is configured as, for example, a piezoelectric element or the like. When the mobile terminal 11 is mounted, the mount sensor 30 notifies the controller 32 to that effect.

The memory 31 may be configured as, for example, a semiconductor memory, a magnetic memory, an optical memory, or the like. For example, the memory 31 stores an image associated with user registration, user information, and setting information acquired from the mobile terminal 11 for each mobile terminal 11 and each registered user. For example, the memory 31 stores the content of a conversation for each user acquired from the mobile terminal 11. For example, the memory 31 stores information for driving the changing mechanism 25 based on an imaging result acquired by the camera 28, as will be described later. For example, the memory 31 stores the behavior history acquired from the mobile terminal 11 for each user.

The controller 32 includes one or more processors, in a manner similar to the controller 22 of the mobile terminal 11. The controller 32 may include one or more memories for storing programs and information being calculated to be used for various operations, in a manner similar to the controller 22 of the mobile terminal 11.

The controller 32 maintains the communication system 10 in the communication mode at least from detection of the mounting of the mobile terminal 11 by the mount sensor 30 until detection of the removal of the mobile terminal 11 by the mount sensor 30, or until a predetermined period of time has elapsed after the detection of the removal. Thus, while the mobile terminal 11 is mounted on the charging stand 12, the controller 32 can cause the mobile terminal 11 to perform at least one of the speech operation and the voice recognition operation. Also, the controller 32 can cause the mobile terminal 11 to perform at least one of the speech operation and the voice recognition operation until the predetermined period has elapsed after the removal of the mobile terminal 11 from the charging stand 12.

While the mobile terminal 11 is mounted on the charging stand 12, the controller 32 determines the presence or absence of a person in the vicinity of the charging stand 12, based on a detection result of the motion sensor 29. When the controller 32 determines that there is a person, the controller 32 activates at least one of the microphone 26 and the camera 28 such that at least one of voice or an image is detected. The controller 32 identifies a user targeted for interaction based on at least one of the detected voice and the detected image. Then, the controller 32 determines a relation of the person located in the vicinity of the charging stand 12 to the user targeted for interaction and determines the privacy level. In the first embodiment, the controller 32 determines the privacy level based on the image.

The controller 32 determines the number of people located in the vicinity of the charging stand 12 (or in the vicinity of the mobile terminal 11 when the mobile terminal 11 is mounted on the charging stand 12) based on, for example, the acquired image. Also, the controller 32 identifies the user targeted for interaction located in the vicinity of the charging stand 12, based on the face, profile, overall contour or the like of the person included in the image. The controller 32 also identifies a person located in the vicinity of the charging stand 12, other than the user targeted for interaction. Here, the controller 32 may further acquire voice. The controller 32 may recognize (or specify) the number of people located in the vicinity of the charging stand 12, based on volume, pitch, and type of acquired voice. The controller 32 may recognize (or specify) the user targeted for interaction, based on the above characters of the voice. The controller 32 may recognize (or specify) a person other than the user targeted for interaction, based on the above characters of the voice.

When the controller 32 identifies the user targeted for interaction, the controller 32 recognizes the relation of the user targeted for interaction to the people located in the vicinity of the charging stand 12. When there are no other people located in the vicinity of the charging stand 12, that is, when only the user targeted for interaction is located in the vicinity of the charging stand 12, the controller 32 determines the privacy level to be the third level. The controller 32 notifies the mobile terminal 11 that the privacy level is determined to be the third level, together with user information of the identified user targeted for interaction. When the user targeted for interaction and a person who has a close relation to the user targeted for interaction (e.g., a family member, a close friend, or the like) alone are located in the vicinity of the charging stand 12, the controller 32 determines the privacy level to be the second level. Here, the controller 32 determines whether the person other than the user targeted for interaction has a close relation to the user targeted for interaction, based on user information transferred to the charging stand 12 from the mobile terminal 11. The controller 32 notifies the mobile terminal 11 that the privacy level is determined to be the second level, together with information regarding the user targeted for interaction and the person located in the vicinity of the charging stand 12. When there is a person (e.g., a stranger) who does not have a close relation to the user targeted for interaction is located in the vicinity of the charging stand 12, the controller 32 determines the privacy level to be the first level. The controller 32 notifies the mobile terminal 11 that the privacy level is determined to be the first level, together with the user information of the user targeted for interaction. When there is a person whose relation to the user targeted for interaction cannot be determined based on the user information is included in the people located in the vicinity of the charging stand 12, the controller 32 determines the privacy level to be the first level and notifies the mobile terminal 11 to that effect. Here, when the controller 32 determines that the content modification operation is not performed (disabled) on all information (e.g. a schedule, a note, e-mail, a phone call, etc.) based on the setting information, the controller 32 does not need to determine the privacy level and notify the mobile terminal 11 of the determination.

While the mobile terminal 11 is mounted on the charging stand 12, the controller 32 causes the camera 28 to continue to capture and searches for the face of the user targeted for interaction. The controller 32 drives the changing mechanism 25 based on a location of the face found in the image, such that the display 19 of the portable terminal 11 is directed to the user.

When the mount sensor 30 detects the mounting of the mobile terminal 11, the controller 32 starts the transition of the communication system 10 to the communication mode. Thus, when the mobile terminal 11 is mounted on the charging stand 12, the controller 32 causes the mobile terminal 11 to start execution of at least one of the speech operation and the voice recognition operation. Also, when the mount sensor 30 detects the mounting of the mobile terminal 11, the controller 32 notifies the mobile terminal 11 that the mobile terminal 11 is mounted on the charging stand 12.

When the mount sensor 30 detects removal of the mobile terminal 11 or when a predetermined time has elapsed after the mount sensor 30 detects the mounting of the mobile terminal 11, the controller 32 ends the communication mode of the communication system 10. Thus, when the mobile terminal 11 is removed, or when the predetermined time has elapsed after the mount sensor 30 detects the mounting of the mobile terminal 11, the controller 32 causes the mobile terminal 11 to end the execution of at least one of the speech operation and the voice recognition operation.

When the controller 32 acquires the content of a conversation for each user from the mobile terminal 11, the controller 32 causes the memory 31 to store the content of the conversation for each mobile terminal 11. The controller 32 causes different mobile terminals 11 which directly or indirectly communicate with the charging stand 12 to share the content of the conversation, as appropriate. Note that the indirect communication with the charging stand 12 includes at least one of communication via a telephone line when the charging stand 12 is connected to the telephone line and communication via the mobile terminal 11 mounted on the charging stand 12.

When the controller 32 acquires an instruction to perform the watching operation from the mobile terminal 11, the controller 32 performs the watching operation. In the watching operation, the controller 32 activates the camera 28 to sequentially capture a specific target. The controller 32 extracts the specific target in the images captured by the camera 28. The controller 32 determines a state of the extracted specific target based on image recognition or the like. The state of the specific target includes, for example, an abnormal state in which the specific user falls down and does not get up or detection of a moving object in a vacant home. When the controller 32 determines that the specific target is in an abnormal state, the controller 32 notifies that the specific target is in an abnormal state to the mobile terminal 11 which issued the instruction to perform the watching operation.

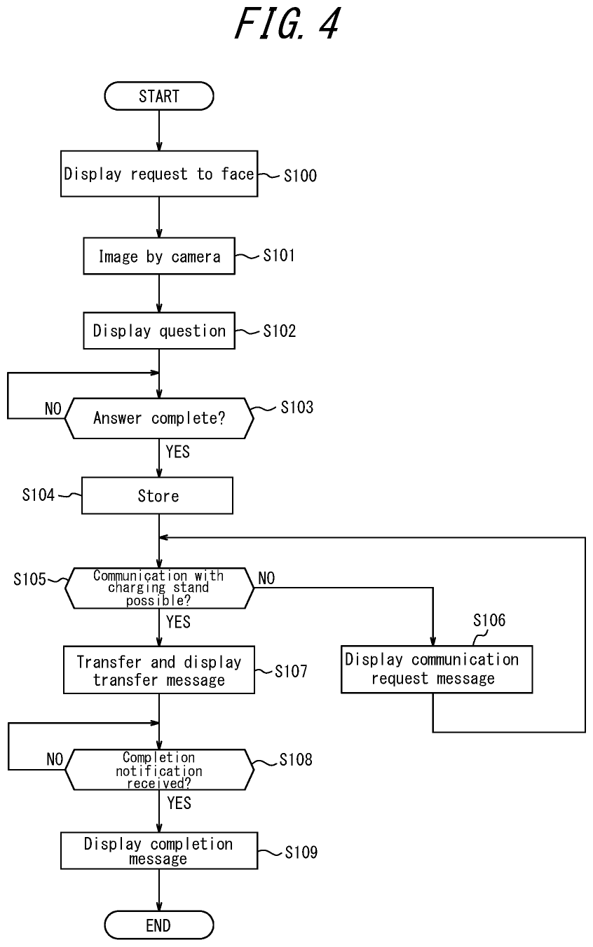

Next, an initial setting operation performed by the controller 22 of the mobile terminal 11 according to the first embodiment will be described with reference to the flowchart of FIG. 4. The initial setting operation starts when the input interface 20 detects an input by the user to start the initial setting.

In step S100, the controller 22 displays a message requesting to face the camera 18 of the mobile terminal 11 on the display 19. After the message is displayed on the display 19, the process proceeds to step S101.

The controller 22 causes the camera 18 to capture an image in step S101. After an image is captured, the process proceeds to step S102.

The controller 22 displays a question asking the name and the attributes of the user on the display 19 in step S102. After the question is displayed, the process proceeds to step S103.

In step S103, the controller 22 determines whether there is an answer to the question of step S102. When there is no answer, the process repeats step S103. When there is an answer, the process proceeds to step S104.

In step S104, the controller 22 associates the image of the face captured in step S102 with the answer to the question detected in step S103 as user information and stores them in the memory 21. After the storing, the process proceeds to step S105.

The controller 22 determines whether the controller 22 can communicate with the charging stand 12 in step S105. When the controller 22 cannot communicate with the charging stand 12, the process proceeds to step S106. When the controller 22 can communicate with the charging stand 12, the process proceeds to step S107.

In step S106, the controller 22 displays a message requesting an action that enables communication with the charging stand 12 on the display 19. The message requesting an action that enables communication may be, for example, “Mount the mobile terminal on the charging stand” in the configuration in which the mobile terminal 11 and the charging stand 12 perform wired communication. The message requesting an action that enables communication may be, for example, “Move the mobile terminal close to the charging stand” in the configuration in which the mobile terminal 11 and the charging stand 12 perform wireless communication. After the message is displayed, the process returns to step S105.

In step S107, the controller 22 transfers the image of the face stored in step S104 and the user information to the charging stand 12. Also, the controller 22 displays an indication that the transfer is in progress on the display 19. After the start of the transfer, the process proceeds to step S108.

The controller 22 determines whether a transfer completion notification is received from the charging stand 12 in step S108. When the transfer completion notification is not received, the process repeats step S108. When the transfer completion notification is received, the process proceeds to step S109.

The controller 22 displays an initial setting completion message on the display 19 in step S109. After the message is displayed, the initial setting ends.

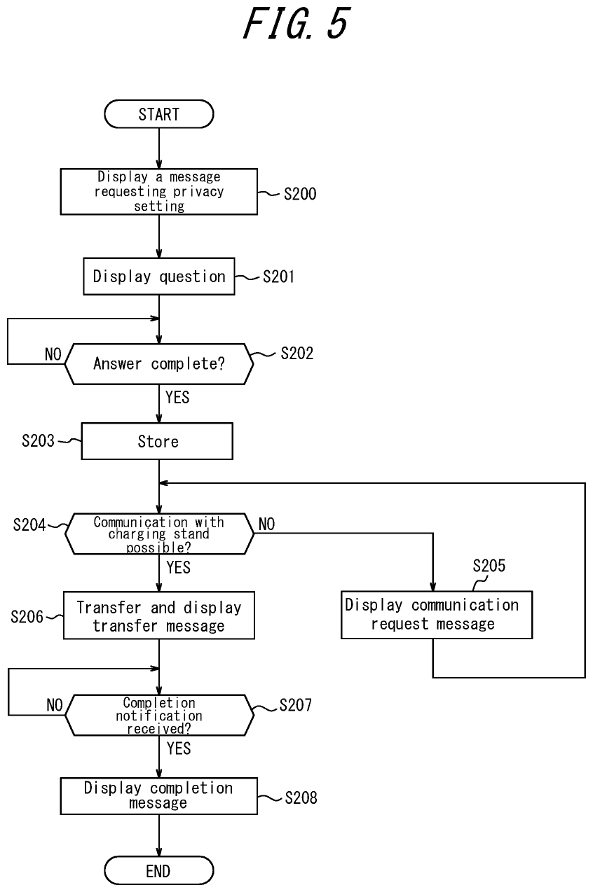

Next, the privacy setting operation performed by the controller 22 of the mobile terminal 11 according to the first embodiment will be described with reference to the flowchart of FIG. 5. The privacy setting operation starts when the input unit 20 detects a user input for starting the privacy setting.

In step S200, the controller 22 displays a message requesting performance of a privacy setting to the user on the display 19. After displaying the message on the display 19, the process proceeds to step S201.

In step S201, when the controller 22 performs verbal notification of, for example, a scheduled plan, a note, received e-mail, or a received phone call, the controller 22 displays a question asking whether the user wishes to protect personal information on the display 19. When the controller 22 performs verbal notification of, for example, the content of a schedule, the content of a note, a sender of e-mail, a title of e-mail, or a name of the caller, the controller 22 displays a question asking whether the user wishes to protect the personal information on the display 19. Further, when the privacy level is determined to be the second level, the controller 22 displays a question asking a range of persons to which the information is to be disclosed. After displaying the question, the process proceeds to step S202.

In step S202, the controller 22 determines whether there is an answer to the question of step S201. When there is no answer, the process repeats step S202. When there is an answer, the process proceeds to step S203.

In step S203, the controller 22 associates the answer detected in step S202 with the question as setting information and stores the setting information in the memory 21. After storing, the process proceeds to step S204.

In step S204, the controller 22 determines whether the controller 22 can communicate with the charging stand 12. When the controller 22 cannot communicate with the charging stand 12, the process proceeds to step S205. When the controller 22 can communicate with the charging stand 12, the process proceeds to step S206.

In step S205, the controller 22 displays a message requesting an action that enables communication with the charging stand 12 on the display 19. The message requesting an action that enables communication may be, for example, the message “Mount the mobile terminal on the charging stand” in the configuration in which the mobile terminal 11 and the charging stand 12 perform wired communication. The message requesting an action that enables communication may be, for example, the message “Move the mobile terminal close to the charging stand” in the configuration in which the mobile terminal 11 and the charging stand 12 perform wireless communication. After the message has been displayed, the process returns to step S204.

In step S206, the controller 22 transfers the setting information stored in step S203 to the charging stand 12. Also, the controller 22 displays a message indicating that the transfer is in progress on the display 19. After the start of the transfer, the process proceeds to step 207.

The controller 22 determines whether a transfer completion notification has been received from the charging stand 12 in step S207. When the transfer completion notification has not been received, the process repeats step S207. When the transfer completion notification has been received, the process proceeds to step S208.

In step S208, the controller 22 displays a privacy setting completion message on the display 19. After the privacy setting completion message has been displayed, the privacy setting operation ends.

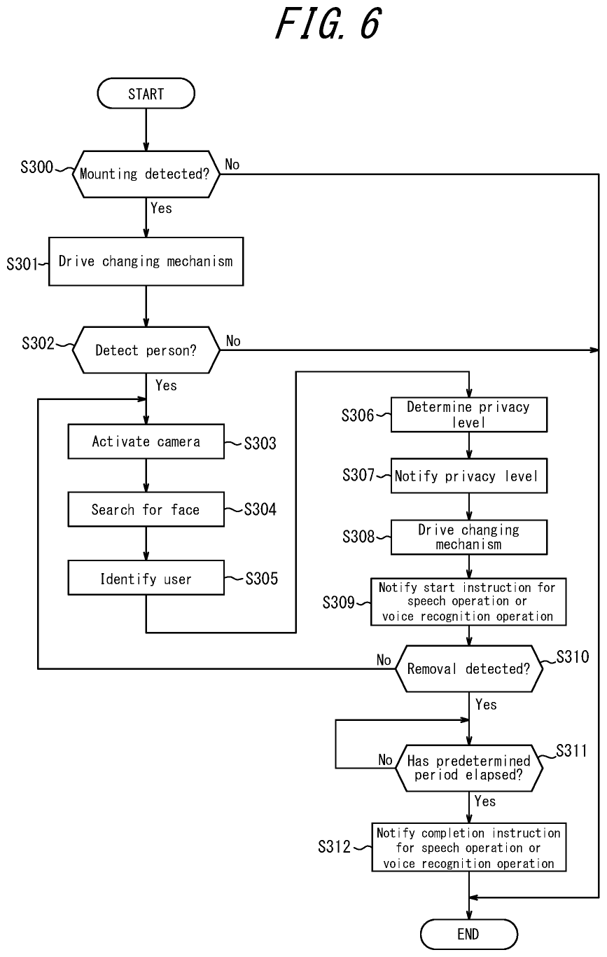

Next, a speech execution determination operation performed by the controller 32 of the charging stand 12 according to the first embodiment will be described with reference to the flowchart of FIG. 6. The controller 32 may periodically start the speech execution determination operation.

In step S300, the controller 32 determines whether the mount sensor 30 has detected mounting of the mobile terminal 11. When the mount sensor 30 has detected mounting, the process proceeds to step S301. When the mount sensor 30 has not detected mounting, the speech execution determination operation ends.

In step S301, the controller 32 drives the changing mechanism 25 and the motion sensor 29 to detect the presence or absence of a person in the vicinity of the charging stand 12. After the changing mechanism 25 and the motion sensor 29 are driven, the process proceeds to step S302.

In step S302, the controller 32 determines whether the motion sensor 29 has detected the presence of a person in the vicinity of the charging stand 12. When the motion sensor 29 has detected the presence of a person, the process proceeds to step S303. When the motion sensor 29 has not detected the presence of a person, the speech execution determination operation ends.

In step S303, the controller 32 drives the camera 28 such that the camera 28 detects an image. After acquiring a detected image, the process proceeds to step S304. Here, the detected image includes at least an image the surroundings of the charging stand 12. In step S303, the controller 32 may activate the microphone 26 for the detection of voice, together with the camera 28.

In step S304, the controller 32 searches for a face of the person included in the image captured in step S303. After the search for the face, the process proceeds to step S305.

In step S305, the controller 32 compares the face found in step S304 with an image of a registered face stored in the memory 31 and thus identifies the user targeted for interaction. The controller 32 identifies a person other than the user targeted for interaction included in the image. That is, when a plurality of people are located in the vicinity of the charging stand 12, the controller 32 identifies each one of the plurality of people. When a person who cannot be identified is included in the image (e.g., a person whose face is not registered), the controller 32 determines that there is a stranger located in the vicinity of the charging stand 12. Also, the controller 32 recognizes a location of the face of the user targeted for interaction within the image, in order to perform an operation to direct the display 19 of the mobile terminal 11 to the face of the user targeted for interaction. After the recognition, the process proceeds to step S306.

In step S306, the controller 32 determines the privacy level, based on the people included in the image identified in step S305. The controller 32 recognizes a relationship or friendship of a person other than the identified user targeted for interaction with the identified user targeted for interaction. After the determination of the privacy level, the process proceeds to step S307.

In step S307, the controller 32 notifies the mobile terminal 11 of the privacy level determined in step S306. After the notification, the process proceeds to step S308.

In step S308, the controller 32 drives the changing mechanism 25 based on the location of the face recognized in step S305, such that the display 19 of the mobile terminal 11 is directed to the face of the user targeted for interaction captured in step S303. After driving the changing mechanism 25, the process proceeds to step S309.

In step S309, the controller 32 notifies the mobile terminal 11 of an instruction to start at least one of the speech operation and the voice recognition operation. After the notification, the process proceeds to step S310.

In step S310, the controller 32 determines whether the mount sensor 30 is detecting removal of the mobile terminal 11. When the mount sensor 30 is not detecting the removal, the process returns to step S303. When the mount sensor 30 is detecting the removal, the process proceeds to step S311.

In step S311, the controller 32 determines whether a predetermined period has elapsed after the detection of the removal of the mobile terminal 11. When the predetermined period has not elapsed, the process returns to step S311. When the predetermined period has elapsed, the process proceeds to step S312.

In step S312, the controller 32 notifies the mobile terminal 11 of an instruction to end at least one of the speech operation and the voice recognition operation.

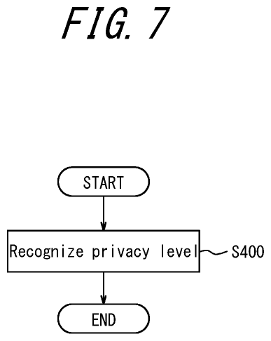

Next, a privacy level recognition operation performed by the controller 22 of the mobile terminal 11 in the first embodiment will be described with reference to the flowchart of FIG. 7. The privacy level recognition operation starts when the notification regarding the privacy level is acquired from the charging stand 12.

The controller 22 recognizes the acquired privacy level in step S400. The controller 22 performs the content modification operation for modifying the content of a notification in the subsequent speech operation, based on the recognized privacy level. After recognition of the privacy level, the privacy level recognition operation ends.

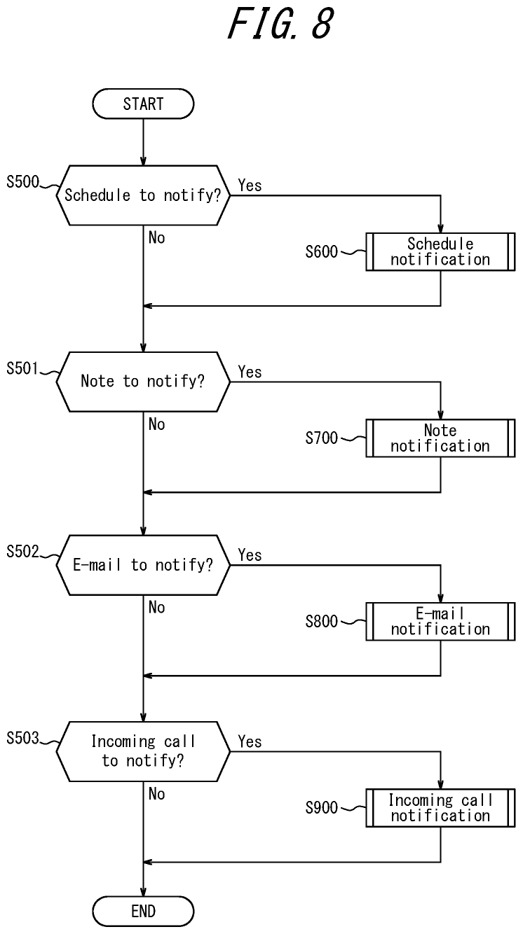

Next, the content modification operation performed by the controller 22 of the mobile terminal 11 in the first embodiment will be described with reference to the flowchart of FIG. 8. The content modification operation starts when, for example, the mobile terminal 11 recognizes the privacy level notified by the charging stand 12. For example, the controller 22 may periodically perform the content modification operation after the mobile terminal 11 recognizes the privacy level, until the mobile terminal 11 receives an instruction to end the speech operation.

In step S500, the controller 22 determines whether there is a scheduled plan to notify the user targeted for interaction. For example, in a case in which there is a scheduled plan to notify the user targeted for interaction which has a predetermined period or less before scheduled date and time, the controller 22 determines that there is a scheduled plan to notify. When there is a scheduled plan to notify, the process proceeds to step S600. When there is no scheduled plan to notify, the process proceeds to step S501.

In step S600, the controller 22 executes a schedule notification subroutine, which will be described later. After executing the schedule notification subroutine, the process proceeds to step S501.

In step S501, the controller 22 determines whether there is a note to notify the user targeted for interaction. For example, when there is a newly registered note that has not been notified to the user targeted for interaction, the controller 22 determines that there is a note to notify. When there is a note to notify, the process proceeds to step S700. When there is no note to notify, the process proceeds to step S502.

In step S700, the controller 22 executes a note notification subroutine, which will be described later. After executing the note notification subroutine, the process proceeds to step S502.

In step S502, the controller 22 determines whether there is an e-mail to notify the user targeted for interaction. For example, when there is newly received e-mail that has not been notified to the user targeted for interaction, the controller 22 determines that there is an e-mail to notify. When there is an e-mail to notify, the process proceeds to step S800. When there is no e-mail to notify, the process proceeds to step S503.

In step S800, the controller 22 executes an e-mail notification subroutine, which will be described later. After executing the e-mail notification subroutine, the process proceeds to step S503.

In step S503, the controller 22 determines whether there is an incoming call to notify the user targeted for interaction. For example, when there is an incoming call addressed to the user targeted for interaction, or when there is a recorded voice mail that has not been notified to the user targeted for interaction, the controller 22 determines that there is an incoming call to notify. When there is an incoming call to notify, the process proceeds to step S900. When there is not an incoming call to notify, the content modification operation ends.

In step S900, the controller 22 executes an incoming call notification subroutine, which will be described later. After executing the incoming call notification subroutine, the content modification operation ends. When there is at least one of a schedule to notify, a note to notify, an e-mail to notify, and an incoming call to notify processed in the content modification operation, the controller 22 outputs the notification subjected to the content modification operation in the speech operation.

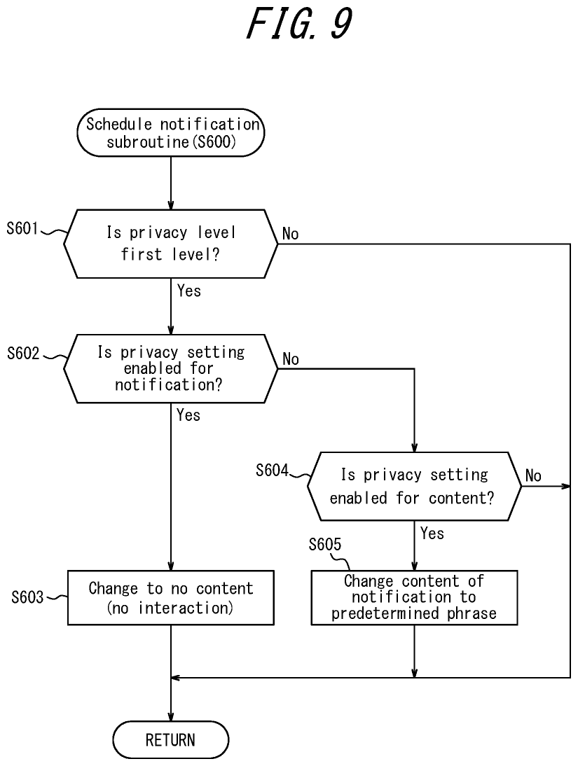

Next, the schedule notification subroutine S600 executed by the controller 22 of the mobile terminal 11 in the first embodiment will be described with reference to the flowchart of FIG. 9.

In step S601, the controller 22 determines whether the privacy level is the first level. When the privacy level is not the first level (i.e., when the privacy level is the second or third level), the controller 22 ends the schedule notification subroutine S600. When the privacy level is the first level, the process proceeds to step S602.

In step S602, the controller 22 determines whether the privacy setting enables verbal notification of the schedule. Here, enabling the privacy setting means enabling privacy protection. The controller 22 refers to the setting information generated in the privacy setting operation and thus can determine whether the privacy setting is enabled for each of predetermined information (a schedule, a note, e-mail, and an incoming call) which are subjected to the content modification operation. When the privacy setting for the verbal schedule notification is enabled, the process proceeds to step S603. When the privacy setting for the verbal schedule notification is disabled, the process proceeds to step S604.

In step S603, the controller 22 modifies the content of the notification to no content. That is, the controller 22 modifies such that there is no speech regarding the schedule.

In step S604, the controller 22 determines whether the privacy setting is enabled for the content of a schedule. When the privacy setting is enabled, the process proceeds to step S605. When the privacy setting is disabled, the controller 22 ends the schedule notification subroutine S600.

In step S605, the controller 22 modifies the content of the notification to a predetermined notification. The predetermined notification is stored in, for example, the memory 21. For example, the controller 22 modifies the content of the notification “There is a welcome/farewell party scheduled at 7 pm today” to “There is a scheduled plan today”, which does not include personal information. After modifying the content of the notification, the controller 22 ends the schedule notification subroutine S600.

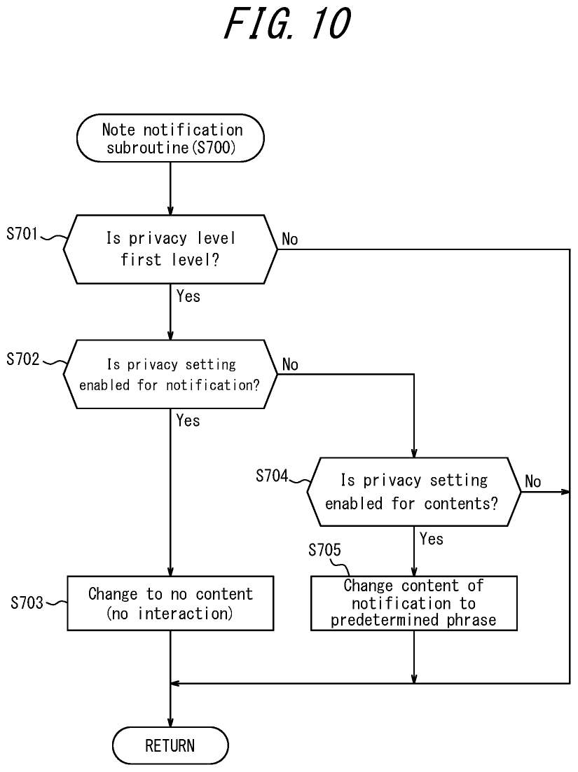

Next, the note notification subroutine S700 performed by the controller 22 of the mobile terminal 11 in the first embodiment will be described with reference to the flowchart of FIG. 10.

In step S701, the controller 22 determines whether the privacy level is the first level. When the privacy level is not the first level (i.e., when the privacy level is the second or third level), the controller 22 ends the note notification subroutine S700. When the privacy level is the first level, the process proceeds to step S702.

In step S702, the controller determines whether the privacy setting is enabled for a verbal note notification, based on the setting information. When the privacy setting is enabled, the process proceeds to step S703. When the privacy setting is disabled, the process proceeds to step S704.

In step S703, the controller 22 modifies the content of a notification to no content. That is, the controller 22 modifies such that there is no speech regarding the note.

In step S704, the controller 22 determines whether the privacy setting is enabled for the content of the note. When the privacy setting is enabled, the process proceeds to step S705. When the privacy setting is disabled, the controller 22 ends the note notification subroutine S700.

In step S705, the controller 22 modifies the content of the notification to a predetermined notification. The predetermined notification is stored in, for example, the memory 21. For example, the controller 22 modifies the content of the notification “Report Y must be submitted tomorrow” to “There is a note today”, which does not include personal information. After modifying the content of the notification, the controller 22 ends the note notification subroutine S600.

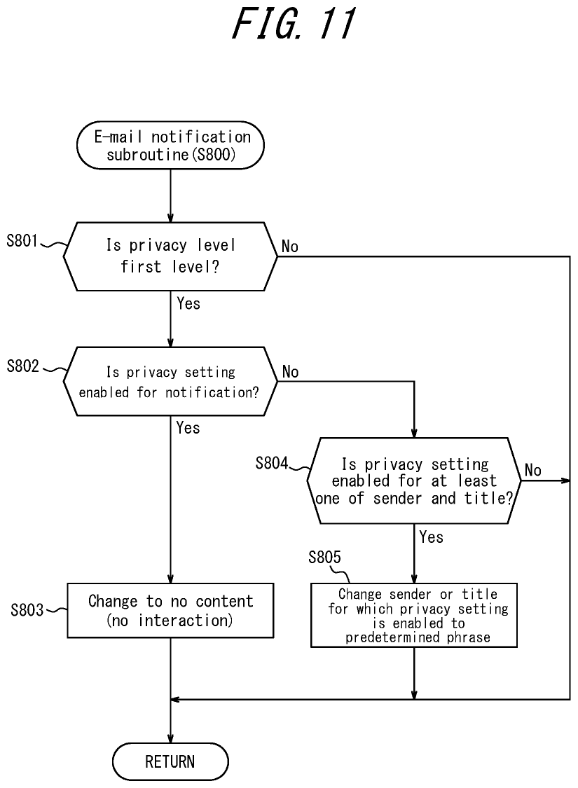

Next, the e-mail notification subroutine S800 performed by the controller 22 of the mobile terminal 11 in the first embodiment will be described with reference to the flowchart of FIG. 11.

In step S801, the controller 22 determines whether the privacy level is the first level. When the privacy level is not the first level (i.e., when the privacy level is the second or third level), the controller 22 ends the e-mail notification subroutine S800. When the privacy level is the first level, the process proceeds to step S802.

In step S802, the controller determines whether the privacy setting is enabled for a verbal e-mail notification, based on the setting information. When the privacy setting is enabled, the process proceeds to step S803. When the privacy setting is disabled, the process proceeds to step S804.

In step S803, the controller 22 modifies the content of a notification to no content. That is, the controller modifies such that there is no speech regarding the message.

In step S804, the controller 22 determines whether the privacy setting is enabled for at least one of a sender and a title of an e-mail. When the privacy setting is enabled, the process proceeds to step S805. When the privacy setting is disabled for both of a sender and a title of e-mail, the controller 22 ends the e-mail notification subroutine S800.

In step S805, the controller 22 modifies the sender or the title to which the privacy setting is enabled to a predetermined notification or no content. The predetermined notification is stored in, for example, the memory 21. For example, when the privacy setting is enabled for a sender and a title of the message, the controller 22 modifies the content of a notification “You've got e-mail regarding Z from Mr. A.” to “You've got e-mail”. When the privacy setting is enabled to a title of the e-mail alone, the controller 22 modifies the content of the notification “You've got e-mail regarding Z from Mr. A.” to “You've got e-mail from Mr. A.” When the privacy setting is enabled to a sender of the e-mail alone, the controller 22 modifies the content of the notification “You've got e-mail regarding Z from Mr. A.” to “You've got e-mail regarding Z.” After modifying the content of the notification, the controller 22 ends the e-mail notification subroutine S800.

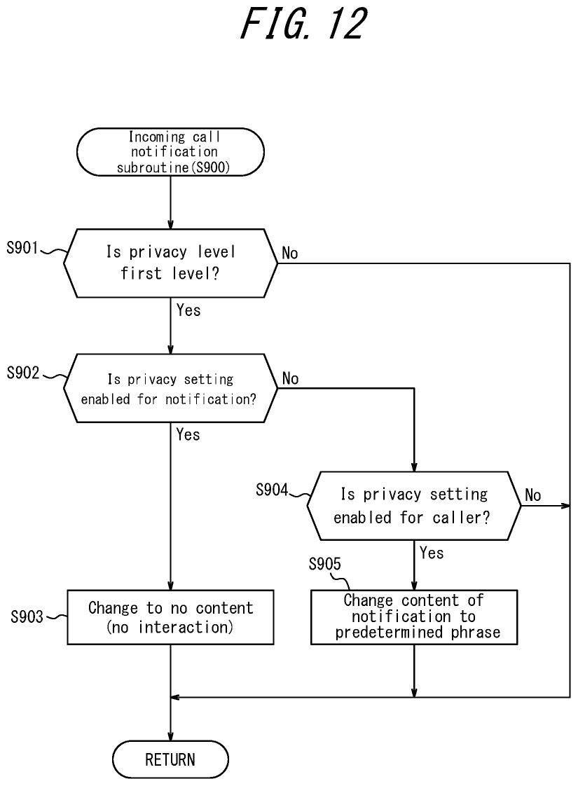

Next, the incoming call notification subroutine S900 performed by the controller 22 of the mobile terminal 11 in the first embodiment will be described with reference to the flowchart of FIG. 12.

In step S901, the controller 22 determines whether the privacy level is the first level. When the privacy level is not the first level (i.e., when the privacy level is the second or third level), the controller 22 ends the incoming call notification subroutine S900. When the privacy level is the first level, the process proceeds to step S902.

In step S902, the controller 22 determines whether the privacy setting is enabled for a verbal incoming call notification, based on the setting information. When the privacy setting is enabled, the process proceeds to step S903. When the privacy setting is disabled, the process proceeds to step S904.

In step S903, the controller 22 modifies the content of a notification to no content. That is, the controller 22 determines to not issue an incoming call notification.

In step S904, the controller 22 determines whether the privacy setting is enabled for a caller of an incoming call. When the privacy setting is enabled, the process proceeds to step S905. When the privacy setting is disabled, the controller 22 ends the incoming call notification subroutine S900.

In step S905, the controller 22 modifies the content of a notification to a predetermined notification. The predetermined notification is stored in, for example, the memory 21. For example, the controller 22 modifies the content of a notification “There was an incoming call from Mr. A.” to “There was an incoming call”, which does not include personal information. For example, the controller 22 modifies the content of a notification “You've got a voice mail from Mr. A.” to “You've got a voice mail.” which does not include personal information. After modifying the content of the notification, the controller 22 ends the incoming call notification subroutine S900.

The interactive electronic apparatus according to the first embodiment configured as described above performs the content modification operation for modifying the content of a notification to be verbally output from the speaker, based on the privacy level of the user targeted for interaction. The privacy level is set in accordance with the people located in the vicinity of the interactive electronic apparatus. The interactive electronic apparatus has the function to output various verbal notifications to the user targeted for interaction and thus is more convenient. However, when there is a person located in the vicinity of the interactive electronic apparatus who does not have a close relationship with the user targeted for interaction, it is preferable to not output the content of a notification that includes personal information. The interactive electronic apparatus according to the first embodiment with the above configuration performs the content modification operation and thus can protect personal information of the user targeted for interaction. Accordingly, the interactive electronic apparatus of the first embodiment has improved functionality, as compared with conventional interactive electronic apparatuses.

Also, the interactive electronic apparatus according to the first embodiment is configured as the mobile terminal 11. The controller 22 performs the content modification operation when the interactive electronic apparatus (i.e., the mobile terminal 11) is mounted on the charging stand 12. Generally, the user of the mobile terminal 11 is likely to start charging the mobile terminal 11 soon after coming home. Thus, the charging stand 12 of the above configuration can notify the user of the message addressed to the user when the user comes home. In this way, the charging stand 12 has improved functionality as compared to conventional charging stands.

When the mobile terminal 11 is mounted on the charging stand 12 according to the first embodiment, the charging stand 12 causes the mobile terminal 11 to perform at least one of the speech operation and the voice recognition operation. The charging stand 12 with the above configuration can function as a companion for the user to talk with, together with the mobile terminal 11 that executes predetermined functions on its own. Thus, the charging stand 12 can function to keep company with elderly persons living alone when they have a meal, and prevent them from feeling lonely. Thus, the charging stand 12 has improved functionality as compared to conventional charging stands.

The charging stand 12 according to the first embodiment causes the mobile terminal 11 to start at least one of the speech operation and the voice recognition operation when the mobile terminal 11 is mounted on the charging stand 12. Thus, the charging stand 12 can cause the mobile terminal 11 to start an interaction with a user simply in response to the mounting of the mobile terminal 11 on the charging stand 12, without the necessity for a complicated input operation.

The charging stand 12 according to the first embodiment causes the mobile terminal 11 to end at least one of the speech operation and the voice recognition operation when the mobile terminal 11 is removed. Thus, the charging stand 12 can end an interaction with a user simply in response to the removal of the mobile terminal 11, without the necessity for a complicated input operation.

The charging stand 12 according to the first embodiment drives the changing mechanism 25 such that the display 19 of the mobile terminal 11 is directed to the user targeted for interaction associated with at least one of the speech operation and the voice recognition operation. Thus, the charging stand 12 can enable the user to feel as if the communication system 10 is an actual person during an interaction with the user.

The charging stand 12 according to the first embodiment can enable different mobile terminals 11 that communicate with the charging stand 12 to share the content of a conversation with a user. The charging stand 12 configured in this manner can enable another user to know the content of a conversation with a specific user. Thus, the charging stand 12 can enable a family member at a remote location to share the content of the conversation and facilitate communication within the family.

The charging stand 12 according to the first embodiment determines a state of a specific target and, when it determines that there is an abnormal state, notifies the user of the mobile terminal 11 to that effect. Thus, the charging stand 12 can watch over the specific target.

The communication system 10 according to the first embodiment determines a notification to be output to the user targeted for interaction, based on the content of past conversations, a voice, a location of the charging stand 12, or the like. Thus, the communication system 10 having the above configuration can have a conversation corresponding to the content of a current conversation by the user, the contents of past conversations by the user, or the current location of the charging stand 12.

The communication system 10 according to the first embodiment learns the behavior history of a particular user and outputs advice to the user. The communication system 10 having the above configuration can notify times for taking medicine, suggestions for meals that match user's preferences, suggestions for a healthy diet for the user, or suggestions for effective and sustainable exercises for the user. Thus, the communication system 10 can remind the user of something or tell the user something new to the user.

Further, the communication system 10 according to the first embodiment notifies information associated with the current location. The communication system 10 having this configuration can inform the user of local information specific to the neighborhood of the user's home.

Next, a communication system according to a second embodiment of the present disclosure will be described. In the second embodiment, each of the operation executed by the controller of the mobile terminal and the operation executed by the controller of the charging stand are slightly different from the respective operations of the first embodiment. Hereinafter, the second embodiment will be described, focusing on different aspects from the first embodiment. Elements having the same configuration as those of the first embodiment are denoted by the same reference signs.

The communications system 10 of the second embodiment includes the mobile terminal 11 and the charging stand 12 as illustrated in FIG. 3, in the same manner as the first embodiment.

The mobile terminal 11 of the second embodiment includes the communication interface 13, the power receiving unit 14, the battery 15, the microphone 16, the speaker 17, the camera 18, the display 19, the input interface 20, memory 21, and the controller 22, in the same manner as the first embodiment. In the second embodiment, the communication interface 13, the power receiving unit 14, the battery 15, the microphone 16, the speaker 17, the camera 18, the display 19, the input interface 20, and the memory 21 have the same configurations and functions as those of the first embodiment. In the second embodiment, the configuration of the controller 22 is the same as that of the first embodiment.

In the second embodiment, in a manner similar to the first embodiment, when, for example, the controller 22 receives the transition instruction to execute transition to the communication mode from the charging stand 12 as described later, the controller 22 controls each constituent element of the mobile terminal 11, in order to perform various functions of the communication mode. In the second embodiment, in a manner different from the first embodiment, the mobile terminal 11 serves as the communication system 10 together with the charging stand 12 and enables an interaction with the user targeted for interaction including unidentified users, observation of a specific user, and sending of a message to a specific user.

The controller 22 executes a registration operation for registering a user to whom the communication mode is executed. The controller 22 starts the registration operation upon detecting, for example, an input requiring user registration made in respect to the input interface 20.

During transition to the communication mode, the controller 22 performs at least one of the speech operation and the voice recognition operation, such that the communication system 10 interacts with the user targeted for interaction.

In the speech operation performed by the controller 22, the contents of speeches are preliminarily classified in association with specific levels of the user targeted for interaction. The specific levels are degrees indicating specificity of the user targeted for interaction. The specific levels include, for example, a first level at which the user targeted for interaction is completely unidentified, a second level at which some attribute of the user targeted for interaction such as age and gender are identified, and a third level at which the user targeted for interaction can be identified as one of registered users. The content of speech is classified in association with the specific levels in such a manner as to increase a degree of correspondence between the content subjected to the speech operation and the user targeted for interaction, as the specific level converges in a direction which specifies the user targeted for interaction.

The content of a speech classified in association with the first level is, for example, the content targeted to an unidentified user or the content whose disclosure is authorized to an unidentified user. The content of a notification classified in association with the first level is a greeting or simple calling such as, for example, “Good morning”, “Good evening”, “Hey”, “Let's talk”, or the like.

The content of a speech classified in association with the second level is, for example, the content targeting an attribute to which the user targeted for interaction belongs, or the content whose disclosure is authorized to the attribute. The content of speech classified in association with the second level is, for example, calling to a specific attribute or a suggestion to the particular attribute. For example, when the attribute is a mother, the content of a speech classified in association with the second level is “Are you mom?”, “How about to cook curry today?”, or the like. Also, when the attribute is a boy, the content of a speech classified in association with the second level is “You are Taro, aren't you?”, “Have you finished your homework?”, or the like.

The content of a speech classified in association with the third level is, for example, the content that targets a specified user and is authorized to be disclosed to the specified user. The content of a speech classified in association with the third level is, for example, a reception notification of e-mail or an incoming call addressed to the identified user, the content of the e-mail or the incoming call, a note or a schedule of the identified user, the behavior history of the identified user, etc. The content of a speech classified in association with the third level is, for example, “Booked a doctor tomorrow”, “You've got e-mail from Mr. Sato”, or the like.

Note that the content whose disclosure is authorized in association with the first to third levels may be set by the user using the input interface 20.

The controller 22 acquires the specific level of the user targeted for interaction in order to perform the speech operation. The controller 22 recognizes the specific level of the user targeted for interaction and determines the content of a speech to be output out of the contents of speeches classified into each of the specific levels, based on at least one of current time, a location of the charging stand 12, whether the mobile terminal 11 is mounted on removed from the charging stand 12, the attribute of the user targeted for interaction, the user targeted for interaction, external information acquired by the communication interface 13, a behavior of the user targeted for interaction, e-mail and a phone call received by the mobile terminal 11, a note and a schedule registered to the mobile terminal 11, a voice of the user, and a past conversation by the user. The location of the charging stand 12, whether the mobile terminal 11 is mounted on removed from the charging stand 12, the attribute of the user targeted for interaction, the user targeted for interaction, and the external information will be described later. The controller 22 drives the speaker 17 to output the content of a speech thus determined.

The controller 22 determines the content of a speech out of, for example, the content of a speech classified in association with the first level, based on the current time, the location of the charging stand 12, whether the mobile terminal 11 is mounted on or removed from the charging stand 12, the external information, a behavior of the user targeted for interaction, or a voice of the user targeted for interaction.

The controller 22 determines the content of a speech out of, for example, the content of a speech classified in association with the second level, based on the current time, the location of the charging stand 12, whether the mobile terminal 11 is mounted on or removed from the charging stand 12, the attribute of the user targeted for interaction, the external information, a behavior of the user targeted for interaction, or a voice of the user targeted for interaction.

The controller 22 determines the content of a speech out of, for example, the content of a speech classified in association with the third level, based on at least one of current time, the location of the charging stand 12, whether the mobile terminal 11 is mounted on or removed from the charging stand 12, the attribute of the user targeted for interaction, the user targeted for interaction, the external information, a behavior of the user targeted for interaction, e-mail or a phone call addressed to the user targeted for interaction received by the mobile terminal 11, a note or a schedule of the user targeted for interaction registered to the mobile terminal 11, a voice of the user targeted for interaction, and a past conversation by the user targeted for interaction.

The controller 22 determines a location of the charging stand 12 in order to determine the content of a speech. The controller 22 determines the location of the charging stand 12 based on a notification regarding the location acquired from the charging stand 12 via the communication interface 13. Alternatively, the controller 22 may determine the location of the charging stand 12 based on at least one of a sound detected by the microphone 16 and an image detected by the camera 18.

For example, when the location of the charging stand 12 is at an entrance hall, the controller 22 determines appropriate words corresponding to when the user is going out or coming home as the content of the speech. For example, when the location of the charging stand 12 is on a dining table, the controller 22 determines appropriate words corresponding to behaviors performed at the dining table such as dining or cooking as the content of the speech. For example, when the location of the charging stand 12 is in a child room, the controller 22 determines appropriate words such as a child topic or words calling for attention of a child as the content of the speech. For example, when the location of the charging stand 12 is in a bedroom, the controller 22 determines appropriate words suitable at bedtime or morning as the content of the speech.

The controller 22 determines whether the mobile terminal 11 is mounted on the charging stand 12 or removed from the charging stand 12, in order to determine the content of the speech. The controller 22 determines whether the mobile terminal 11 is mounted or removed, based on a mounting notification acquired from the charging stand 12. For example, while a notification indicating that the mobile terminal 11 is mounted on the charging stand 12 is being received from the charging stand 12, the controller 22 determines that the mobile terminal 11 is mounted on the charging stand 12. When the controller 22 stops receiving the notification, the controller 22 determines that the mobile terminal 11 is removed from the charging stand 12. Alternatively, the controller 22 may determine whether the mobile terminal 11 is mounted on the charging stand 12, based on whether the power receiving unit 14 can receive electric power from the charging stand 12, or whether the communication interface 13 can communicate with the charging stand 12.

When the mobile terminal 11 is mounted on the charging stand 12, the controller 22 determines words suitable for a user who is entering the location of the charging stand 12 as the content of a speech. Also, when the mobile terminal 11 is removed from the charging stand 12, the controller 22 determines words suitable for a user leaving the location of the charging stand 12 as the content of a speech.

The controller 22 determines a behavior of a user targeted for interaction, in order to determine the content of a speech. For example, when the controller 22 determines that the charging stand 12 is located at the entrance hall, the controller 22 determines whether the user targeted for interaction is leaving home or coming home, based on an image acquired from the charging stand 12 or an image acquired from the camera 18. Alternatively, the controller 22 may determine whether the user targeted for interaction is leaving home or coming home, based on an image detected by the camera 18 or the like. The controller 22 determines appropriate words as the content of a speech, in consideration of a combination of whether the mobile terminal 11 is mounted on the charging stand 12 and whether the user is leaving home or coming home.

The controller 22 determines the attribute of the user targeted for interaction, in order to determine the content of a speech. The controller 22 determines the attribute of the user targeted for interaction based on a notification of the user targeted for interaction received from the charging stand 12 and the user information stored in the memory 21. The controller 22 determines appropriate words suitable for the gender, the age bracket, the company name, or the school name of the user targeted for interaction as the content of a speech.

In order to determine the content of a speech, the controller 22 drives the communication interface 13 and acquires external information such as weather forecast and traffic conditions. Base on the acquired external information, the controller 22 determines words for calling attention associated with the weather or a congestion state of a transport to be used by the user as the content of a speech.

In the voice recognition operation, the controller 22 recognizes the content spoken by the user by performing morphological analysis of a voice detected by the microphone 16 in accordance with the location of the charging stand 12. The controller 22 performs a predetermined operation based on the recognized content. The predetermined operation may be, for example, a speech operation on the recognized content as described above, search for desired information, display of a desired image, or making a phone call or sending e-mail to an intended addressee.

While the communication system 10 is in transition to the communication mode, the controller 22 stores the continuously performed speech operation and the voice recognition operation described above in the memory 21 and learns the content of a conversation associated with the specific user targeted for interaction. The controller 22 utilizes the learned content of the conversation to determine the content of a later speech. The controller 22 may transfer the learned content of the conversation to the charging stand 12.

Also, when the communication system 10 is in transition to the communication mode, the controller 22 learns a behavior history of a specific user targeted for interaction from the content of a conversation with the user and an image captured by the camera 18 during a speech to the user. The controller 22 informs the user of advice based on the learned history of the user. Advice may be provided as speech via the speaker 17 or an image displayed on the display 19. Such an advice may include, for example, notification of a time to take a medicine, a suggestion for a meal that matches preference of the user, a suggestion for a healthy diet for the user, a suggestion for an effective exercise the user can continue, or the like. The controller 22 notifies the charging stand 12 of the learned behavior history in association with the user.

Further, when the communication system 10 is in transition to the communication mode, the controller 22 detects the current location of the mobile terminal 11. Detection of the current location is based on, for example, a location of a base station in communication with or the GPS incorporated in the mobile terminal 11. The controller 22 notifies the user of local information associated with the detected current location. The notification of the local information may be generated as speech by the speaker 17 or an image displayed on the display 19. The local information may include, for example, sale information for a neighborhood store.

When the input interface 20 detects a request for starting the watching operation associated with a specific target while the communication system 10 is in transition to the communication mode, the controller 22 notifies the charging stand 12 of the request. The specific target may be, for example, a specific registered user, a room in which the charging stand 12 is located, or the like.

The watching operation is performed by the charging stand 12, regardless of whether or not the mobile terminal 11 is mounted on the charging stand 12. When the controller 22 receives a notification from the charging stand 12 that is performing the watching operation indicating that the specific target is in an abnormal state, the controller 22 notifies the user to that effect. The notification to the user may be generated as voice via the speaker 17 or as a warning image displayed on the display 19.

The controller 22 performs the data communication operation to send/receive e-mail or the phone call operation to display an image using a browser, based on an input to the input interface 20, regardless of whether the communication system 10 is in transition to the communication mode.

In a manner similar to the first embodiment, the charging stand 12 of the second embodiment includes the communication interface 23, the power supply unit 24, the changing mechanism 25, the microphone 26, the speaker 27, the camera 28, the motion sensor 29, the mount sensor 30, the memory 31, and the controller 32. In the second embodiment, the communication interface 23, the power supply unit 24, the changing mechanism 25, the microphone 26, the speaker 27, the camera 28, the display 29, and the mount sensor 30 have the same configurations and functions as those of the first embodiment. In the second embodiment, the configurations of the memory 31 and the controller 32 are the same as those of the first embodiment.

In the second embodiment, the memory 31 stores at least one of a voice or an image unique to each conceivable location, in order to, for example, determine the location of the charging stand 12, in addition to the information stored in the first embodiment. In the second embodiment, the storage unit 31 further stores, for example, the location determined by the controller 32.

When the charging stand 12 receives electric power from, for example, a grid, the controller 32 determines a location of the charging stand 12 based on at least one of a voice detected by the microphone 26 and an image detected by the camera 28. The controller 32 determines the location by, for example, acquiring a characteristic speech pattern or a sound unique to each of a plurality of conceivable locations from the memory 31 or the like and comparing them with the contents of speeches by a plurality of users or a sound detected by the microphone 26. For example, the controller 32 determines a location by acquiring a characteristic outline of an object unique to each of a plurality of conceivable locations from the memory 31 or the like and comparing them with an outline included in an image detected by the camera 28. The controller 32 notifies the mobile terminal 11 mounted on the charging stand 12 of the location.

The controller 32 causes the communication system 10 to maintain the communication mode at least from when the mount sensor 30 detects the mounting of the mobile terminal 11 to when the mount sensor 30 detects the removal of the mobile terminal 11, or until a predetermined period of time has elapsed after the detection of the removal. Thus, while the mobile terminal 11 is mounted on the charging stand 12, the controller 32 can cause the mobile terminal 11 to perform at least one of the speech operation and the voice recognition operation. The controller 32 can cause the mobile terminal 11 to perform at least one of the speech operation and the voice recognition operation until the predetermined period has elapsed after the removal of the mobile terminal 11 from the charging stand 12.

While the controller 32 maintains the communication system 10 in the communication mode, the controller 32 determines the presence or absence of a person located in the vicinity of the charging stand 12, based on a result of detection by the motion sensor 29. When the controller 32 determines that there is a person, the controller 32 drives at least one of the microphone 26 and the camera 28, such that at least one of a voice or an image is detected. The controller 32 determines the specific level of the user targeted for interaction, based on at least one of the detected voice or the detected image. In the present embodiment, the controller 32 determines the specific level of the user targeted for interaction based on both the sound and the image.

The controller 32 determines the attribute of the user targeted for interaction such as age and gender, based on, for example, volume, pitch, and a type of an acquired voice. The controller 32 determines the attribute of the user targeted for interaction such as age and gender, based on, for example, a height and an overall contour of the user targeted for interaction included in the acquired image. The controller 32 identifies the user targeted for interaction, based on the face of the user targeted for interaction in the acquired image.

When the controller 32 identifies the user targeted for interaction, the controller 32 determines the specific level to be the third level and notifies the identified user targeted for interaction and the third level to the mobile terminal 11. When the controller 32 determines some of the attribute of the user targeted for interaction, the controller 32 determines the specific level to be the second level and notifies the attribute and the second level to the mobile terminal 11. When the controller 32 cannot determine the attribute of the user targeted for interaction at all, the controller 32 determines the specific level to be the first level and notifies the first level to the mobile terminal 11.

While the controller 32 continues to determine the specific level to be the third level, the controller 32 causes the camera 28 to continue to capture and searches for the face of the specific user targeted for interaction in each of the images. The controller 32 drives the changing mechanism 25 based on the location of the face found in the image, such that the display 19 of the mobile terminal 11 is directed to the user.

When the mount sensor 30 detects mounting of the mobile terminal 11, the controller 32 starts the transition of the communication system 10 to the communication mode. Thus, when the mobile terminal 11 is mounted on the charging stand 12, the controller 32 causes the mobile terminal 11 to start at least one of the speech operation and the voice recognition operation. When the mount sensor 30 detects mounting of the mobile terminal 11, the controller 32 notifies the mobile terminal 11 that the mobile terminal 11 is mounted on the charging stand 12.

When the mount sensor 30 detects removal of the mobile terminal 11 or when a predetermined time has elapsed after the mount sensor 30 detects the mounting of the mobile terminal 11, the controller 32 ends the communication mode of the communication system 10. Thus, when the mobile terminal 11 is removed, or when the predetermined time has elapsed after the mount sensor 30 detects the mounting of the mobile terminal 11, the controller 32 causes the mobile terminal 11 to end the execution of at least one of the speech operation and the voice recognition operation.

When the controller 32 acquires the content of a conversation for each user from the mobile terminal 11, the controller 32 causes the memory 31 to store the the content of the conversation for each mobile terminal 11. The controller 32 causes different mobile terminals 11 which directly or indirectly communicates with the charging stand 12 to share the content of the conversation, as appropriate. Note that the indirect communication with the charging stand 12 includes at least one of communication via a telephone line when the charging stand 12 is connected to the telephone line and communication via the mobile terminal 11 mounted on the charging stand 12.

When the controller 32 acquires an instruction to perform the watching operation from the mobile terminal 11, the controller 32 performs the watching operation. In the watching operation, the controller 32 activates the camera 28 to sequentially image a specific target. The controller 32 extracts the specific target in the images captured by the camera 28. The controller 32 determines a state of the extracted specific target based on image recognition or the like. The state of the specific target includes, for example, an abnormal state in which the specific user falls down and does not get up or a detection of a moving object in a vacant home. When the controller 32 determines that the specific target is in an abnormal state, the controller 32 notifies that the specific target is in an abnormal state to the mobile terminal 11 having issued the instruction to perform the watching operation.

When the mobile terminal 11 is removed, the controller 32 causes the speaker 27 to inquire whether there is a message to the user. The controller 32 performs the voice recognition operation on a voice detected by the microphone 26 and determines whether the voice is a message. Note that the controller 32 can determine whether the voice detected by the microphone 26 is a message without inquiring whether there is a message. When the voice detected by the microphone 26 is a message, the controller 32 stores the message in the memory 31.

The controller 32 determines whether the voice determined to be a message specifies a recipient user. When a user is not specifies, the controller 32 outputs a request to specify a recipient user. The request may be output as, for example, a speech from the speaker 27. The controller 32 performs the voice recognition operation and recognizes the recipient user.

The controller 32 reads a attribute of the recipient user from the memory 31. When the user is the owner of the mobile terminal 11 stored in the memory 31 according to the attribute of the user read out from the memory 31, the controller 32 waits until the mobile terminal 11 is mounted on the mount sensor 30. When the mount sensor 30 detects the mounting of the mobile terminal 11, the controller 32 causes the communication interface 23 to determine whether the owner of the mobile terminal 11 is the recipient user. When the owner of the mobile terminal 11 mounted on the mount sensor 30 is the recipient user, the controller 32 causes output of the message stored in the memory 31. The message may be output as, for example, a speech from the speaker 27.

When the controller 32 does not detect the mounting of the mobile terminal 11 until when a first period has elapsed after acquiring the message, the controller 32 transmits the message to the mobile terminal 11 owned by the recipient user. The controller 32 may transmit the message in the form of audio data or data in letters. The first period is, for example, a time considered to be a message retention period and determined at the time of manufacture based on statistical data or the like.

When the user is not the owner of the mobile terminal 11 according to the attribute of the user read out from the memory 31, the controller 32 activates the camera 28 and starts the determination whether the user's face is included in a captured image. When the user's face is included in an image, the controller 32 causes the memory 31 to output the message stored therein.

Further, the controller 32 analyzes the content of the stored message. The controller 32 determines whether speeches corresponding to the content of the message are stored in the memory 31. The speeches corresponding to the content of the message is determined in advance with respect to messages that are presumed to be generated or performed for a specific user at a particular time and stored in the memory 31. Such speeches may include, for example, “Coming home soon” corresponding to “See you later”, “Have you taken the pill?” corresponding to “Take the pill”, “Have you washed your hands?” corresponding to “Wash your hands”, “Have you set the alarm?” corresponding to “Go to bed early”, and “Have you brushed your teeth?” corresponding to “Brush your teeth”.

A part of each speech corresponding to the content of the message is associated with the location of the charging stand 12. For example, a speech to be output in a bedroom such as “Have you set the alarm?” corresponding to “Go to bed early” is selected only when the charging stand 12 is located in a bedroom.

When a speech corresponding to the content of a message is stored, the controller 32 identifies the specific user associated with the occurrence or execution of the matter related to the message. The controller 32 analyzes a behavior history of the specific user and estimates a timing the matter related to the message is occurred or performed.

For example, regarding the message “See you later”, the controller 32 analyzes a period from when the message is input to when the user comes home, based on the behavior history of the user who left the message, and determines an elapse of the time. Also, regarding the message “Take the pills”, the controller 32 estimates a time when a user as a recipient of the message should take the pills, based on a behavior history of the user. Regarding the message “Wash your hands”, the controller 32 estimates when a next meal starts, based on the behavior history of the user as a recipient of the message. Regarding the message “Go to bed early”, for example, the controller 32 estimates the time to go bed, based on the behavior history of the user as a recipient of the message. Regarding the message “Brush your teeth”, for example, the controller 32 estimates a finishing time of the next meal and a bed time, based on the behavior history of the user as a recipient of the message.

The controller 32 activates the camera 28 at an estimated time and starts the determination whether the face of the specified user is included in a captured image. When the face of the specified user is included, the controller 32 outputs a message related to the content of the message. The message may be in the form of, for example, a voice output from the speaker 27.

When the recipient user of the message is the owner of the mobile terminal 11 and, simultaneously, a second period has elapsed from the estimated time, the controller 32 transmits a message related to the content of the message. The controller 32 may transmit the speech in the form of audio data or data in letters. The second period is, for example, a duration from the estimated time to a time at which the matter related to the message should be securely occurred or performed, and determined at the time of manufacture based on statistical data or the like.

Next, an initial setting operation performed by the controller 22 of the mobile terminal 11 according to the second embodiment will be described. The initial setting operation according to the second embodiment is the same as that of the first embodiment (see FIG. 4).

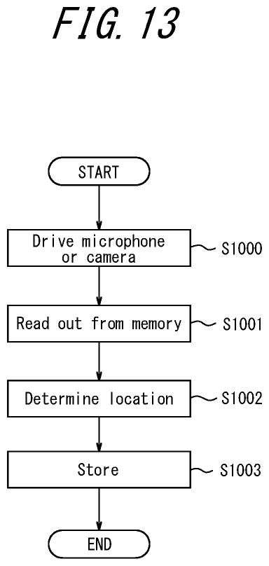

Next, a location determination operation performed by the controller 32 of the charging stand 12 according to the second embodiment will be described with reference to the flowchart of FIG. 13. The location determination operation starts when, for example, a predetermined time has elapsed after the power source of the charging stand 12 is turned on.

The controller 32 drives at least one of the microphone 26 and the camera 28 in step S1000. After the driving, the process proceeds to step S1001.

In step S1001, the controller 32 reads out at least one of a voice or an image unique to each conceivable location from the memory 31 to be used for the determination of the location. After reading out the voice or image, the process proceeds to step S1002.

In step S1002, the controller 32 compares at least one of the voice detected by the microphone 26 and the image detected by the camera 28, which is activated in step S1000, with at least one of the voice and the image read out from the memory 31 in step S1001. The controller 32 determines the location of the charging stand 12 based on the comparison. After the determination, the process proceeds to step S1003.

In step S1003, the controller 32 stores the location of the charging stand 12 determined in step S1002 in the memory 31. After the storing, the location determination operation ends.

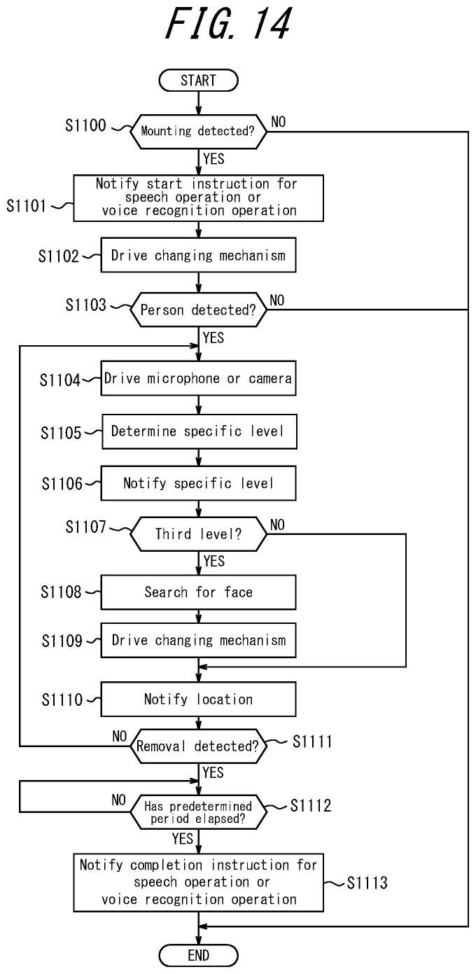

Next, a speech execution determination operation performed by the controller 32 of the charging stand 12 according to the second embodiment will be described with reference to the flowchart of FIG. 14. The speech execution determination operation starts periodically.

In step S1100, the controller 32 determines whether the mount sensor 30 is detecting the mounting of the mobile terminal 11. When the mount sensor 30 is detecting the mounting, the process proceeds to step S1101. When the mount sensor 30 is not detecting the mounting, the speech execution determination operation ends.

In step S1101, the controller 32 instructs the mobile terminal 11 to start at least one of the speech operation and the voice recognition operation. After the instruction, the process proceeds to step S1102.

In step S1102, the controller 32 drives the changing mechanism 25 and the motion sensor 29 to detect the presence or absence of a person in the vicinity of the charging stand 12. After driving the changing mechanism 25 and the motion sensor 29, the process proceeds to step S1103.

In step S1103, the controller 32 determines whether the motion sensor 29 is detecting a person located in the vicinity of the charging stand 12. When a person located in the vicinity is detected, the process proceeds to step S1104. When a person located in the vicinity is not detected, the speech execution determination operation ends.

In step S1104, the controller 32 drives the microphone 26 and the camera 28 to detect a voice and an image, respectively, in the vicinity. After acquiring detected voice and image, the process proceeds to step S1105.

In step S1105, the controller 32 determines the specific level of the user targeted for interaction based on the voice and image acquired in step S1104. After the determination, the process proceeds to step S1106.

In step S1106, the controller 32 notifies the mobile terminal 11 of the specific level determined in step S1104. After the notification, the process proceeds to step S1107.

In step S1107, the controller 32 determines whether the specific level determined in step S1105 is the third level. When the specific level is the third level, the process proceeds to step S1108. When the specific level is not the third level, the process proceeds to step S1110.

In step S1108, the controller 32 searches for a face of a person in the acquired image. Also, the controller 32 detects a location of the face within the image. After the searching for the face, the process proceeds to step S1109.

In step S1109, the controller 32 drives the changing mechanism 25 such that the display 19 of the mobile terminal 11 is directed to the face of the user targeted for interaction captured in step S1103, based on the location of the face detected in step S1108. After driving the changing mechanism 25, the process proceeds to step S1110.

In step S1110, the controller 32 reads out the location of the charging stand 12 from the memory 31 and notifies the mobile terminal 11 of the location. After the notification to the mobile terminal 11, the process proceeds to step S1111.

In step S1111, the controller 32 determines whether the mount sensor 30 is detecting removal of the mobile terminal 11. When the mount sensor 30 is not detecting removal, the process returns to step S1104. When the mount sensor 30 is detecting removal, the process proceeds to step S1112.

In step S1112, the controller 32 determines whether a predetermined period has elapsed after the detection of the removal. When the predetermined period has not elapsed, the process returns to step S1112. When the predetermined period has elapsed, the process proceeds to step S1113.

In step S1113, the controller 32 notifies the mobile terminal 11 of an instruction to end at least one of the speech operation and the voice recognition operation. Also, the controller 32 causes the speaker 27 to inquire whether there is a message. After the notification to the mobile terminal 11, the speech execution determination operation ends.

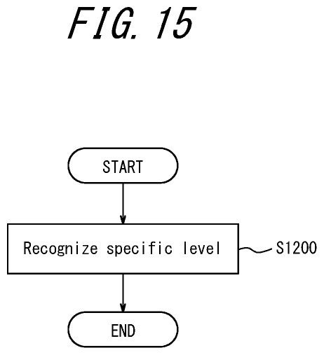

Next, a specific level recognition operation performed by the controller 22 of the mobile terminal 11 according to the second embodiment will be described with reference to the flowchart of FIG. 15. The specific level recognition operation starts when the charging stand 12 notifies the mobile terminal 11 of the specific level.

In step S1200, the controller 22 recognizes the acquired specific level and uses the specific level to determine the content of a speech in the speech operation to be performed later, out of the contents of speeches classified in association with the specific level. After recognition of the specific level, the specific level recognition operation ends.

Next, a location determination operation performed by the controller 22 of the mobile terminal 11 according to the second embodiment will be described with reference to the flowchart of FIG. 6. The location determination operation starts when the charging stand 12 notifies the mobile terminal 11 of the location.

The controller 22 analyzes a location acquired from the charging stand 12 in step S1300. After the analysis, the process proceeds to step S1301.

In step S1301, the controller 22 determines whether the location of the charging stand 12 analyzed in step S1300 is at the entrance hall. When the location is at the entrance hall, the process proceeds to step S1400. When the location is not at the entrance hall, the process proceeds to step S1302.

In step S1400, the controller 22 performs an entrance hall interaction subroutine, which will be described later. After the entrance hall interaction subroutine is performed, the location determination operation ends.

In step S1302, the controller 22 determines whether the location of the charging stand 12 analyzed in step S1300 is on a dining table. When the location is on the dining table, the process proceeds to step S1500. When the location is not on the dining table, the process proceeds to step S1303.

In step S1500, the controller 22 performs a dining table interaction subroutine, which will be described later. After the dining table interaction subroutine is performed, the location determination operation ends.

In step S1603, the controller 22 determines whether the location of the charging stand 12 analyzed in step S1300 is in a child room. When the location is in the child room, the process proceeds to step S1600. When the location is not in the child room, the process proceeds to step S1304.

In step S1600, the controller 22 performs a child room interaction subroutine, which will be described later. After the child room interaction subroutine is performed, the location determination operation ends.

In step S1304, the controller 22 determines whether the location of the charging stand 12 analyzed in step S1300 is in a bedroom. When the location is in a bedroom, the process proceeds to step S1700. When the location is not in a bedroom, the process proceeds to step S1305.

In step S1700, the controller 22 performs a bedroom interaction subroutine, which will be described later. After the bedroom interaction subroutine is performed, the location determination operation ends.

In step S1305, the controller 22 performs the speech operation and the voice recognition operation using a general speech which does not concern the location to determine the content of a speech. After the speech operation and the voice recognition operation using the general speech are performed, the location determination operation ends.

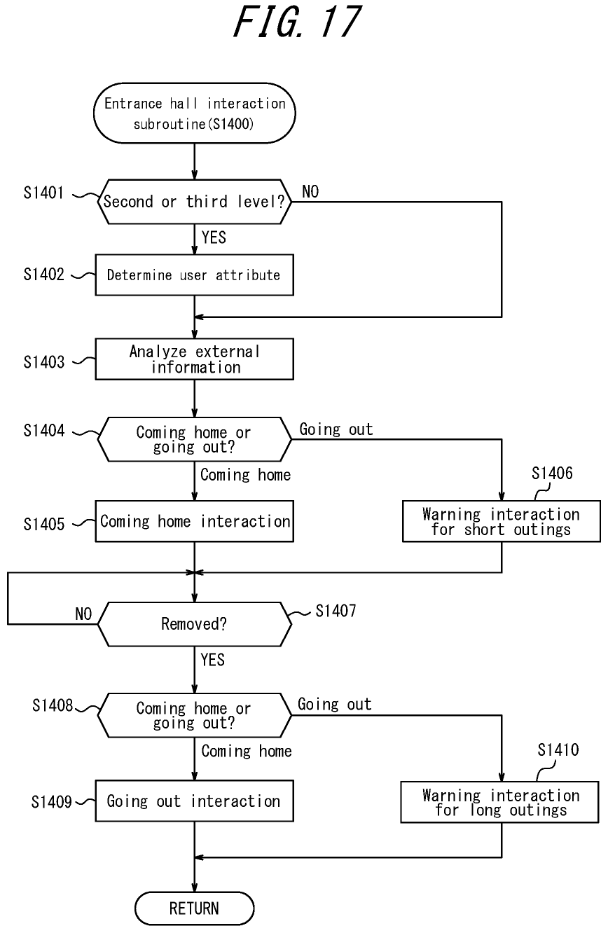

Next, the entrance hall interaction subroutine S1400 performed by the controller 22 of the mobile terminal 11 according to the second embodiment will be described with reference to the flowchart of FIG. 17.

In step S1401, the controller 22 determines whether the specific level is the second level or the third level. When the specific level is the second level or the third level, the process proceeds to step S1042. When the specific level is not the second level or the third level, the process proceeds to step S1403.

In step S1402, the controller 22 determines the attribute of the user targeted for interaction. When the specific level is the second level, the controller 22 determines the attribute of the user based on the attribute notified by the charging stand 12 together with the specific level. When the specific level is the third level, the controller 22 determines the attribute of the user based on the user notified by the charging stand 12 together with the specific level, and user information of the user read out from the memory 31. After the determination, the process proceeds to step S1403.

The controller 22 analyzes external information in step S1403. After the analysis, the process proceeds to step S1404.

In step S1404, the controller 22 determines whether the behavior of the user corresponds to coming home or going out, based on a behavior of the user targeted for interaction. When the user came home, the process proceeds to step S1405. When the user is going out, the process proceeds to step S1406.

The controller 22 executes a welcome home speech in step S1405, based on the specific level recognized in the specific level recognition operation, the attribute of the user determined in step S1402, and the external information analyzed in step S1403. For example, the controller 22 causes the speaker 17 to output a speech such as “Welcome home!” regardless of the attribute of the user and the external information. For example, when the attribute of the user indicates a child, the controller 22 causes the speaker 17 to output a speech such as “Did you learn a lot?” For example, when the attribute of the user indicates an adult, the controller 22 causes the speaker 17 to output a speech such as “Have a good evening.” For example, when the controller 22 determines that it is raining based on the external information, the controller 22 causes the speaker 17 to output a speech such as “Did you get wet?” For example, when the controller 22 determines that the commuter train was delayed based on the external information, the controller 22 causes the speaker 17 to output a speech such as “How unlucky to have a delayed train”. After execution of the welcome home speech, the process proceeds to step S1407.

In step S1046, the controller 22 performs a warning interaction for calling attention corresponding to short outings, based on the specific level recognized in the specific level recognition operation. For example, the controller 22 causes the speaker 17 to output a speech such as “Don't forget your mobile terminal.”, “Are you coming back soon?”, “Lock the door for safety”, or the like. After execution of the warning interaction for calling attention corresponding to short outings, the process proceeds to step S1407.

In step S1407, the controller 22 determines whether the mobile terminal 11 is removed from the charging stand 12. When the mobile terminal 11 is not removed, the process repeats step S1407. When the mobile terminal 11 is removed, the process proceeds to step S1408.

In step S1408, the controller 22 determines whether an action of the user indicates coming home or going out, based on a behavior of the user targeted for interaction. In the configuration in which the mobile terminal 11 and the charging stand 12 perform wired communication, the controller 22 determines whether the user came home or the user is going out, based on an image detected by the camera 18. When the controller 22 determines that the user came home, the process proceeds to step S1409. When the controller 22 determines that the user is going out, the process proceeds to step S1410.

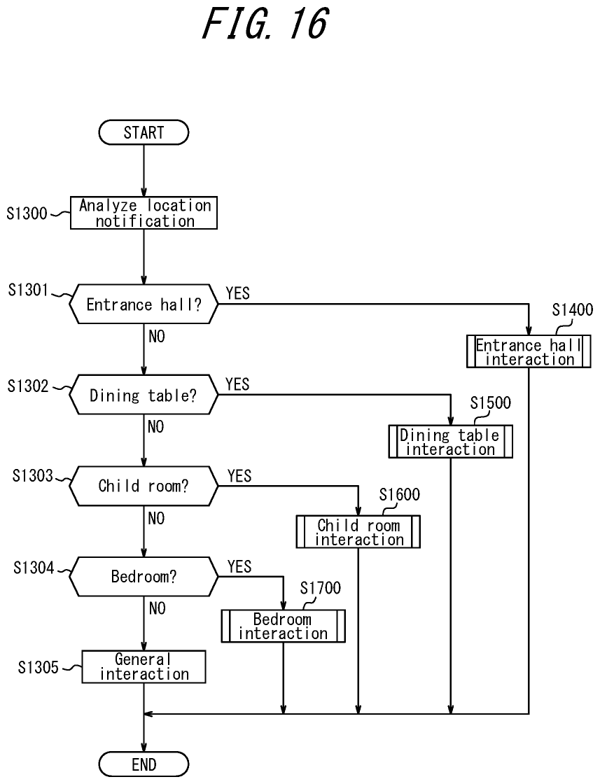

In step S1409, the controller 22 executes a going out speech, based on the specific level recognized in the specific level recognition operation, the attribute of the user determined in step S1402, and the external information analyzed in step S1403. For example, the controller 22 causes the speaker 17 to output a speech such as “Do your best!”, “Have a nice day!”, or the like, regardless of the attribute of the user and the external information. For example, when the attribute of the user indicates a child, the controller 22 causes the speaker 17 to output a speech such as “Don't follow strangers”. For example, when the attribute of the user indicates an adult, the controller 22 causes the speaker 17 to output a speech such as “Have you locked the door?”, “Make sure the fire is out.”, or the like. For example, when the controller 22 determines that it is raining based on the external information, the controller 22 causes the speaker 17 to output a speech such as “Have you got an umbrella?” or the like. For example, when the attribute of the user indicates an adult and, simultaneously, the controller 22 determines that it is raining based on the external information, the controller 22 causes the speaker 17 to output a speech such as “Have you taken laundry in?” or the like. For example, when the controller 22 determines that it will be cold based on the external information, the controller 22 causes the speaker 17 to output a speech such as “Have you got your coat?” or the like. For example, when the controller 22 determines that the commuter train for the school or the work is delayed based on the external information, the controller 22 cause the speaker 17 to output a speech such as “Yamanote line is delayed” or the like. For example, when the attribute of the user indicates an adult and, simultaneously, the controller 22 determines that there is a traffic congestion in the route for the work based on the external information, the controller 22 causes the speaker 17 to output a speech such as “There is a traffic congestion between home and the train station” or the like. After execution of the going out speech, the process ends the entrance hall interaction subroutine S1400 and returns to the location determination operation illustrated in FIG. 16 performed by the controller 22.

In step S1410, the controller 22 performs a warning interaction for calling attention corresponding to long outings, based on the specific level recognized in the specific level recognition operation. For example, the controller 22 causes the speaker 17 to output a speech such as “Have you locked windows?”, “Make sure the fire is out”, or the like. After performing the warning interaction for calling attention corresponding to long outings, the process ends the entrance hall interaction subroutine S1400 and returns to the location determination operation illustrated in FIG. 16 performed by the controller 22.

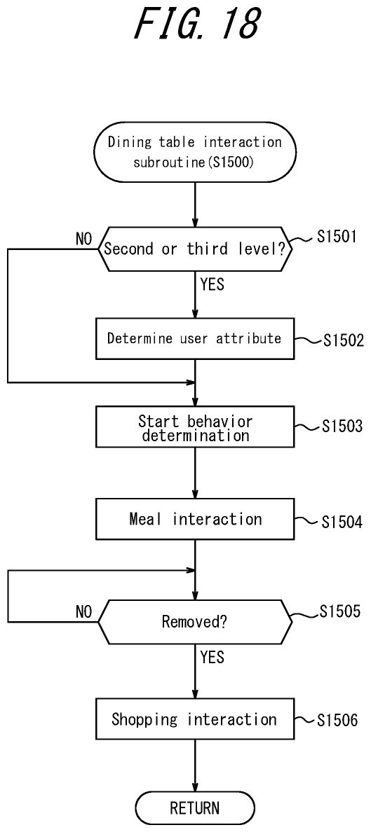

Next, the dining table interaction subroutine S1500 performed by the controller 22 of the mobile terminal 11 according to the second embodiment will be described with reference to the flowchart of FIG. 18.

In step S1501, the controller 22 determines whether the specific level is the second level or the third level. When the specific level is the second level or the third level, the process proceeds to step S1502. When the specific level is not the second level or the third level, the process proceeds to step S1503.

In step S1502, the controller 22 determines the attribute of the user targeted for interaction. When the specific level is the second level, the controller 22 determines the attribute of the user, based on the attribute notified by the charging stand 12 together with the specific level. When the specific level is the third level, the controller 22 determines the attribute of the user based on the user notified by the charging stand 12 together with the specific level, and user information of the user read out from the memory 31. After the determination, the process proceeds to step S1503.

In step S1503, the controller 22 starts determining a behavior of the specific user. After starting the determination, the process proceeds to step S1504.

In step S1504, the controller 22 performs a meal speech, based on the specific level recognized in the specific level recognition operation, the attribute of the user determined in step S1502, and the behavior of the user started in step S1503. For example, when the attribute of the user indicates a child and, simultaneously, it is immediately before a meal time according to a behavior history, the controller 22 causes the speaker 17 to output a speech such as “Getting hungry?” or the like. For example, when the controller 22 determines that the user is preparing a meal, the controller 22 causes the speaker 17 to output a speech such as “What's for dinner tonight?” or the like. For example, when the user's behavior corresponds to immediately after starting a meal, the controller 22 causes the speaker 17 to output a speech such as “Let's eat various food!” or the like. For example, when the controller 22 determines that the user's behavior indicates that the user has started eating more than a suggested amount based on the attribute of the user, the controller 22 causes the speaker 17 to output a speech such as “Don't eat too much!” or the like. After performing the meal speech for a meal, the process proceeds to step S1505.

In step S1505, the controller 22 determines whether the mobile terminal 11 is removed from the charging stand 12. When the mobile terminal 11 is not removed, the process repeats step S1505. When the mobile terminal 11 is removed, the process proceeds to step S1506.

In step S1506, the controller 22 executes a shopping speech based on the specific level recognized in the specific level recognition operation and the attribute of the user determined in step S1502. For example, when the attribute of the user indicates an adult, the controller 22 causes the speaker 17 to output a speech such as “Sardines are in season now.”, “Have you got a shopping list?”, or the like. After performing the shopping speech, the process ends the dining table interaction subroutine S1500 and returns to the location determination operation illustrated in FIG. 16 performed by the controller 22.

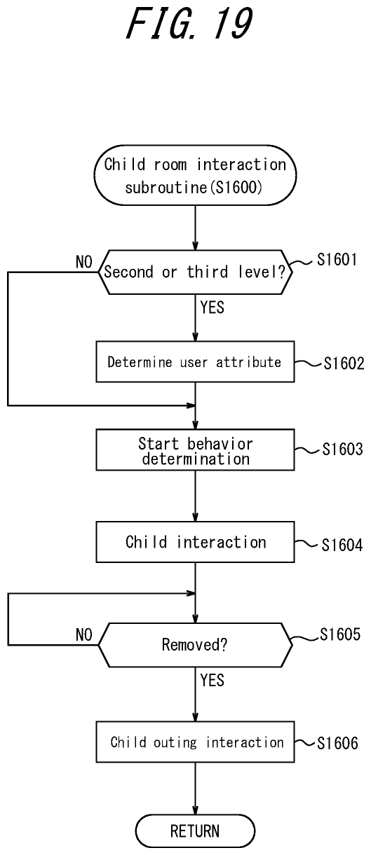

Next, the child room interaction subroutine S1600 performed by the controller 22 of the mobile terminal 11 according to the second embodiment will be described with reference to the flowchart of FIG. 19.

In step S1601, the controller 22 determines whether the specific level is the second level or the third level. When the specific level is the second level or the third level, the process proceeds to step S1602. When the specific level is not the second level or the third level, the process proceeds to step S1603.

The controller 22 determines an attribute of a user targeted for interaction in step S1602. After the determination, the process proceeds to step S1603.

The controller 22 starts the determination of a behavior of the user targeted for interaction in step S1603. After the start of the determination, the process proceeds to step S1604.

In step S1604, the controller 22 executes a child interaction, based on the specific level recognized in the specific level recognition operation, the attribute of the user determined in step S1602, and the behavior of the user started in step S1603. For example, when the attribute of the user indicates a student of an elementary school or a junior high school and, simultaneously, the current time corresponds to a time for coming home based on the behavior history, the controller 22 causes the speaker 17 to output a speech such as “How was the school?”, “Any message to parents?”, “Any letter for parents?”, or the like. For example, when the behavior of the user corresponds to play, the controller 22 causes the speaker 17 to output a speech such as “Have you finished your homework?” or the like. For example, when the behavior of the user corresponds to immediately after starting study, the controller 22 causes the speaker 17 to output a speech such as “Ask questions any time!” or the like. For example, when the controller 22 determines that a predetermined period has elapsed after determining that the behavior of the user corresponds to studying, the controller 22 causes the speaker 17 to output a speech such as “Have a break.” or the like. For example, when the attribute of the user indicates a preschooler or a lower grader of an elementary school, the controller 22 causes the speaker 17 to output questions such as a simple addition, subtraction, or multiplication. The controller 22 may cause the speaker 17 to output a popular topic among a gender or preschoolers, lower graders, middle graders, upper graders, junior high school students, or senior high school students, based on the attribute of the user. After executing the child interaction, the process proceeds to step S1605.

The controller 22 determines whether the mobile terminal 11 is removed from the charging stand 12 in step S1605. When the mobile terminal 11 is not removed, the process repeats step S1605. When the mobile terminal 11 is removed, the process proceeds to step S1606.

In step S1606, the controller 22 performs a child outing interaction, based on the specific level recognized in the specific level recognition operation and the attribute of the user determined in step S1602. For example, when the current time corresponds to the time to go to school based on the behavior history, the controller 22 causes the speaker 17 to output a speech such as “Got everything?”, “Got your homework?”, or the like. For example, when it is summertime, the controller 22 causes the speaker 17 to output a speech such as “Don't forget your hat!” or the like. For example, the controller 22 causes the speaker 17 to output a speech such as “Got your handkerchief?” or the like. After performing the child outing interaction, the process ends the child room interaction subroutine S1600 and returns to the location determination operation performed by the controller 22 illustrated in FIG. 16.

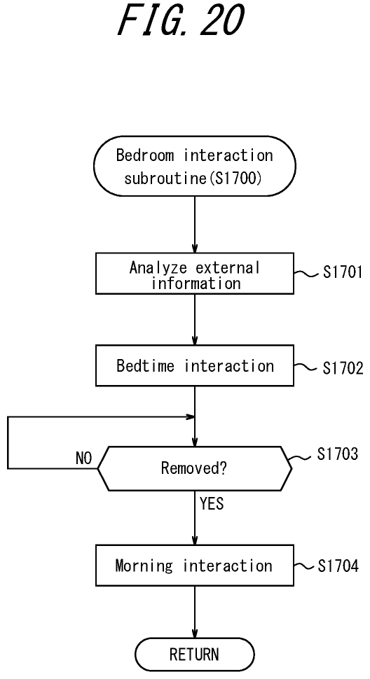

Next, the bedroom interaction subroutine S1700 performed by the controller 22 of the mobile terminal 11 according to the second embodiment will be described with reference to the flowchart in FIG. 20.

The controller 22 analyzes the external information in step S1701. After the analysis, the process proceeds to step S1702.

In step S1702, the controller 22 performs a bedtime speech, based on the specific level recognized in the specific level recognition operation and the external information analyzed in step S1701. For example, the controller 22 causes the speaker 17 to output a speech such as “Good night”, “Have you locked the door?”, “Make sure the fire is out”, or the like, regardless of the external information. For example, when the predicted temperature is lower than the previous day according to the external information, the controller 22 causes the speaker 17 to output a speech such as “It will be chilly tonight.” or the like. For example, when the predicted temperature is higher than the previous day according to the external information, the controller 22 causes the speaker 17 to output a speech such as “It will be hot tonight.” or the like. After execution of the bedtime speech, the process proceeds to step S1703.

The controller 22 determines whether the mobile terminal 11 is removed from the charging stand 12 in step S1703. When the mobile terminal 11 is not removed, the process repeats step S1703. When the mobile terminal 11 is removed, the process proceeds to step S1704.

In step S1704, the controller 22 performs a morning speech, based on the specific level recognized in the specific level recognition operation and the external information analyzed in step S1701. For example, the controller 22 causes the speaker 17 to output a speech such as “Good morning!” regardless of the external information. For example, when the controller 22 determines that the predicted temperature is lower than the previous day based on the external information, the controller 22 causes the speaker 17 to output a speech such as “It will be chilly today. You might want a sweater.” or the like. For example, when the controller 22 determines that the predicted temperature is higher than the previous day based on the external information, the controller 22 causes the speaker 17 to output a speech such as “It will be warm today. You might want to be lightly dressed.” or the like. For example, when the controller 22 determines that it is raining based on the external information, the controller 22 causes the speaker 17 to output a speech such as “It's raining. You′d better leave soon.” or the like. For example, when the controller 22 determines that the commuter train for the school or the work is delayed based on the external information, the controller 22 causes the speaker 17 to output a speech such as “The train is delayed. You′d better leave soon.” or the like. After execution of the morning speech, the process ends the bedroom interaction subroutine S1700 and returns to the location determination operation illustrated in FIG. 16 performed by the controller 22.

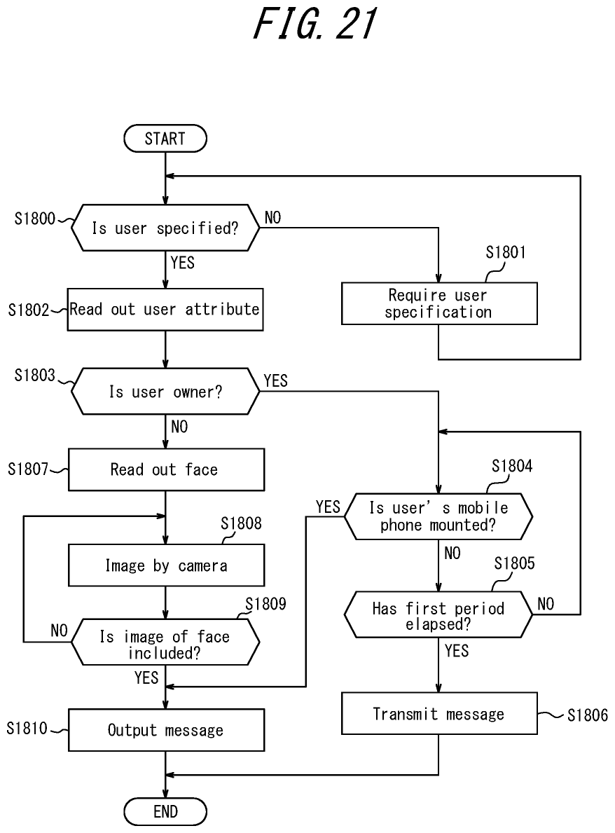

Next, a message operation performed by the controller 32 of the charging stand 12 according to the second embodiment will be described with reference to the flowchart of FIG. 21. The message operation starts when, for example, the controller 32 determines that a voice detected by the microphone 26 is speaking a message.

The controller 32 determines whether the message specifies a recipient user in step S1800. When the message does not specify a recipient user, the process proceeds to step S1801. When the message specifies a recipient user, the process proceeds to step S1802.

The controller 32 causes the speaker 27 to output a request to specify a recipient user in step S1801. After the output of the request, the process returns to step S1800.

The controller 32 reads out a attribute of the recipient user from the memory 31 in step S1802. After the reading, the process proceeds to step S1803.

In step S1803, the controller 32 determines whether the recipient user is the owner of the mobile terminal 11 stored in the charging stand 12, based on the attribute of the user read out in step S1802. When the recipient user is the owner, the process proceeds to step S1804. When the recipient user is not the owner, the process proceeds to step S1807.

The controller 32 determines whether the mobile terminal 11 of the recipient user is mounted in step S1804. When the mobile terminal 11 is mounted, the process proceeds to step S1810. When the mobile terminal 11 is not mounted, the process proceeds to step S1805.

In step S1805, the controller 32 determines whether a first period has elapsed after acquisition of the message. When the first period has not elapsed, the process returns to step S1804. When the first period has elapsed, the process proceeds to step S1806.

The controller 32 transmits the message to the mobile terminal 11 of the recipient user via the communication interface 23 in step S1806. After the transmission, the message operation ends.

In step S1807, to which the process proceeds when it is determined in step S1803 that the recipient user is not the owner of the mobile terminal 11, the controller 32 reads out an image of the face of the recipient user from the memory 31. After the reading, the process proceeds to step S1808.

The controller 32 causes the camera 28 to capture an image of the surroundings in step S1808. After the capturing, the process proceeds to step S1809.

In step S1809, the controller 32 determines whether the image of the face read out in step S1807 is included the image captured in step S1808. When the image of the face is not included, the process returns to step S1808. When the image of the face is included, the process proceeds to step S1810.

The controller 32 causes the speaker 27 to output the message in step S1810. After the output, the message operation ends.

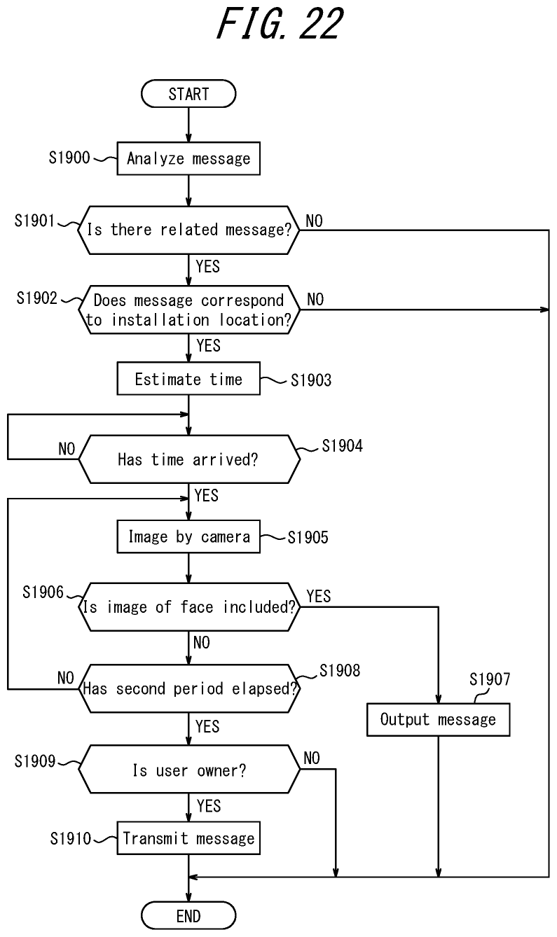

Next, a messaging operation performed by the controller 32 of the charging stand 12 according to the second embodiment will be described with reference to the flowchart of FIG. 22. The messaging operation starts when, for example, the controller 32 determines that a voice detected by the microphone 26 is speaking a message.

The controller 32 analyzes the content of the message in step S1900. After the analysis, the process proceeds to step S1901.

In step S1901, the controller 32 determines whether a message related to the message analyzed in step S1900 is stored in the memory 31. When a related message is stored, the process proceeds to step S1902. When a related message is not stored, the messaging operation ends.

In step S1902, the controller 32 determines whether the related message determined to have been stored in step S1901 corresponds to the current location of the charging stand 12. When the related message corresponds to the current location, the process proceeds to step S1903. When the related message does not correspond to the current location, the messaging operation ends.

In step S1903, the controller 32 identifies a specific user related to an occurrence or execution of a matter associated with the message analyzed in step S1900. Also, the controller 32 reads out the image of the face of the specific user from the memory 31. Further, the controller 32 estimates the time of the occurrence or execution of the matter associated with the message, by analyzing the behavior history of the specific user. After the estimation, the process proceeds to step S1904.

In step S1104, the controller 32 determines whether the time has reached the time estimated in step S1903. When the time has not reached, the process returns to step S1904. When the time has reached, the process proceeds to step S1905.

The controller 32 causes the camera 28 to capture an image of the surroundings in step S1905. After the capturing, the process proceeds to step S1906.

In step S1906, the controller 32 determines whether the image of the face read out in step S1903 is included in the image captured in step S1905. When the image of the face is included, the process proceeds to step S1907. When the image of the face is not included, the process proceeds to step S1908.

In step S1907, the controller 32 causes the speaker 27 to output the speech determined to have been stored in step S1901. After the output, the messaging operation ends.

In step S1908, the controller 32 determines whether a second period has elapsed after the determination in step S1904 that the estimated time has reached. When the second period has not elapsed, the process returns to step S1905. When the second period has elapsed, the process proceeds to step S1909.

In step S1909, the controller 32 determines whether a recipient user of the message is the owner of the mobile terminal 11 known to the charging stand 12. When the recipient user is the owner, the process proceeds to step S1910. When the recipient user is not the owner, the messaging operation ends.

In step S1910, the controller 32 transmits the message to the mobile terminal 11 owned by the recipient user via the communication interface 23. After the transmission of the speech, the messaging operation ends.

The interactive electronic apparatus 11 according to the second embodiment configured as described above performs the speech operation using the content corresponding to the specific level of the user targeted for interaction. Preferably, the interactive electronic apparatus 11 performs a conversation with the content that may make the user feel like as if the user is talking to an actual person. To that end, the interactive electronic apparatus 11 needs to have a conversation with the content that includes personal information of the user to the specific user. On the other hand, it is also desired that the interactive electronic apparatus 11 have a conversation with the content that is suitable for each of the users located in the vicinity of the communication system 10. In conversations with various users, it is necessary to keep privacy of personal information of a particular user. Thus, the interactive electronic apparatus 11 of the second embodiment configured as described above can perform conversations with various users, while outputting speeches of the appropriate content to the specific user. Accordingly, the interactive electronic apparatus 11 has an improved function, as compared to conventional interactive apparatuses.

Also, the interactive electronic apparatus 11 according to the second embodiment increases the degree of correspondence between the content subjected to the speech operation and the user targeted for interaction, as the specific level converges in the direction which specifies the user targeted for interaction. Thus, the interactive electronic apparatus 11 outputs the content of a speech whose disclosure is authorized to the user targeted for interaction and can make the user feel as if the user is talking to an actual person.

The charging stand 12 according to the present embodiment having the above configuration outputs a message to a user registered to the mobile terminal 11 when the mobile terminal 11 is mounted on the charging stand 12. Generally, the user of the mobile terminal 11 is likely to start charging the mobile terminal 11 soon after coming home. Thus, the charging stand 12 of the above configuration can notify the user of the message addressed to the user when the user comes home. In this way, the charging stand 12 has improved functionality as compared to conventional charging stands.

When an image captured by the camera 28 includes a specified user, the charging stand 12 according to the second embodiment outputs a message to the specified user. The charging stand 12 having the above configuration can notify a message to a user who does not own the mobile terminal 11. Thus, the charging stand 12 has improved functionality as compared to conventional charging stands.

The charging stand 12 according to the second embodiment outputs a speech related to a message addressed to the user at timing based on the behavior history of the user. The charging stand 12 having the above configuration can notify the user of a matter related to the message at appropriate timing

The mobile terminal 11 according to the second embodiment performs at least one of the speech operation and the voice recognition operation using the content corresponding to a location of the charging stand 12 that supplies electric power to the mobile terminal 11. Generally, people change a topic of a conversation based on a location. Thus, the mobile terminal 11 is configured as described above and thus can cause the communication system 10 to output a more appropriate speech corresponding to each situation. Accordingly, the mobile terminal 11 has improved functionality as compared to conventional mobile terminals

The mobile terminal 11 according to the second embodiment performs at least one of the speech operation and the voice recognition operation using the content corresponding to when the mobile terminal 11 is mounted on the charging stand 12 and when the mobile terminal 11 is removed from on the charging stand 12. The mount and removal of the mobile terminal 11 on/from the charging stand 12 can be associated with particular behaviors of the user. Thus, the mobile terminal 11 having this configuration can enable the communication system 10 to output a more appropriate speech in accordance with a specific behavior of the user. In this way, the mobile terminal 11 has improved functionality as compared to conventional mobile terminals

The mobile terminal 11 according to the second embodiment performs at least one of the speech operation and the voice recognition operation using the content corresponding to an attribute of a user targeted for interaction. Generally, people have different topics between their genders or generations. Thus, the mobile terminal 11 having the above configuration can cause the communication system 10 to output a more appropriate speech to the user targeted for interaction.

The mobile terminal 11 according to the second embodiment performs at least one of the speech operation and the voice recognition operation using the content corresponding to the external information. The mobile terminal 11 having the above configuration as a constituent element of the communication system 10 can provide a desired advice under the condition of the mount of the mobile terminal 11 on the charging stand or the removal of the mobile terminal 11 from the charging stand 12 at a location of the speech based on the external information.

When the mobile terminal 11 is mounted on the charging stand 12 according to the second embodiment, the charging stand 12 causes the mobile terminal 11 to perform at least one of the speech operation and the voice recognition operation, in a manner similar to the first embodiment. Thus, the charging stand 12 has improved functionality as compared to conventional charging stands.

The charging stand 12 according to the second embodiment causes the mobile terminal 11 to start at least one of the speech operation and the voice recognition operation when the mobile terminal 11 is mounted on the charging stand 12, in a manner similar to the first embodiment. Thus, the charging stand 12 of the second embodiment can cause the mobile terminal 11 to start an interaction with a user, simply in response to the mounting of the mobile terminal 11 on the charging stand 12, without the necessity for a complicated input.

The charging stand 12 according to the second embodiment causes the mobile terminal 11 to end at least one of the speech operation and the voice recognition operation when the mobile terminal 11 is removed, in a manner similar to the first embodiment. Thus, the charging stand 12 of the second embodiment can end an interaction with a user or the like, simply in response to the removal of the mobile terminal 11, without the necessity for a complicated input.

The charging stand 12 according to the second embodiment drives the changing mechanism 25 such that the display 19 of the mobile terminal 11 is directed to the user targeted for interaction concerned in at least one of the speech operation and the voice recognition operation, in a manner similar to the first embodiment. Thus, the charging stand 12 of the second embodiment can enable the user to feel like as if the communication system 10 is an actual person during an interaction with the user.

The charging stand 12 according to the second embodiment can enable different mobile terminals 11 that communicate with the charging stand 12 to share the content of a conversation to a user, in a manner similar to the first embodiment. Thus, the charging stand 12 of the second embodiment can enable a family member at a remote location to share the content of the conversation and facilitate communication within the family.

The charging stand 12 according to the second embodiment determines a state of a specific target and, when determines that there is an abnormal state, notifies the user of the mobile terminal 11 to that effect, in a manner similar to the first embodiment. Thus, the charging stand 12 of the second embodiment can watch over the specific target.

The communication system 10 according to the second embodiment determines a speech to output to a user targeted for interaction, based on the contents of past conversations, a voice, a location of the charging stand 12, or the like, in a manner similar to the first embodiment. Thus, the communication system 10 of the second embodiment can have a conversation with the content corresponding to a current conversation by the user, the contents of past conversations by the user, or the location of the charging stand 12.

The communication system 10 according to the second embodiment learns the behavior history of a specific user and outputs an advice to the user, in a manner similar to the first embodiment. Thus, the communication system 10 of the second embodiment can remind the user of something or tell the user something new to the user.

Further, the communication system 10 according to the second embodiment notifies information associated with the current location, in a manner similar to the first embodiment. Thus, the communication system 10 of the second embodiment can inform the user of local information specific to a neighborhood of the user's home.

Although the disclosure has been described based on the figures and the embodiments, it is to be understood that various changes and modifications may be implemented based on the present disclosure by those who are ordinarily skilled in the art. Accordingly, such changes and modifications are included in the scope of the disclosure.

For example, at least a portion of the operation (e.g., the content modification operation based on the privacy level) performed by the controller 22 of the mobile terminal 11 in the first and second embodiments may be performed by the controller 32 of the charging stand 12. In this case, the microphone 26, the speaker 27, and the camera 28 of the charging stand 12 may be driven during a speech to a user, or the microphone 16, the speaker 17, and the camera 18 of the mobile terminal 11 may be driven via the communication interfaces 23 and 13.

Also, the operation (e.g., the privacy level determination operation) performed by the controller 32 of the charging stand 12 in the first and second embodiments may be performed by the controller 22 of the mobile terminal 11.

In the first embodiment, also, the example variations described above may be combined, such that the controller 32 of the charging stand 12 performs the content modification operation, the speech operation, and the voice recognition operation, and the controller 22 of the mobile terminal 11 performs the privacy level determination operation. In the second embodiment, also, the example variations described above may be combined, such that the controller 32 of the charging stand 12 performs the speech operation, the voice recognition operation, the conversation learning, the behavior history learning, the advising based on the behavior history learning, and the notification of information associated with a current location, and the controller 22 of the mobile terminal 11 determines whether to perform at least one of the speech operation and the voice recognition operation.

Further, although the controller 22 of the mobile terminal 11 performs the registration operation in the first and second embodiments, the controller 32 of the charging stand 12 may perform the registration operation.

In the first embodiment, the first level as the privacy level is considered to be a non-privacy state in the schedule notification subroutine, the note notification subroutine, the e-mail notification subroutine, and the incoming call notification subroutine (step S601, step S701, step S801, and step S901). However, in each of the subroutines (independently of each other), the privacy level may be considered to be the non-privacy state when the privacy level is the first level or the second level.

In the first embodiment, when the privacy level is the second level or the third level, it is not considered to be a privacy state, and the content of a speech are not modified. Here, when the privacy level is the second level, the content of a speech may be modified from the content of a speech at the third level (the content that completely includes personal information). For example, in a case in which a schedule is to be verbally output and the content of a speech at the third level are “There is a welcome/farewell party scheduled at the location X from 7 pm”, the controller 22 may change the content of the speech to “There is a welcome/farewell party scheduled today”. That is, the controller 22 may output the content of a speech at the second level, from which the content determined to be personal information (time and location in this example) is omitted. At this time, the content of the speech is adjusted to gradually include personal information in accordance with the first to third levels of the privacy level. Thus, personal information may be appropriately protected in accordance with the privacy level.

In the first embodiment, the privacy setting operation is performed upon receiving an input to the input interface 20 by the user. The privacy setting operation generates setting information indicating whether privacy setting is enabled for each of predetermined information subjected to the content modification operation (i.e., a schedule, a note, e-mail, and an incoming call). The setting information can be changed by performing the privacy setting operation again. Here, a change of the entire setting information (change between enabling and disabling the privacy setting) can be made at once by a particular conversation between the interactive electronic apparatus and the user. For example, when the user speaks a specific phrase (e.g., “By the way”) after a conversation about the weather, the controller 22 may renew the setting information and enables (or disables) the privacy setting for all of schedule, note, e-mail, and incoming call. For example, when the user displays a registered image (e.g., an image of a character) on the touch panel and touches particular positions of the registered image in a specific order (e.g., eye, mouth, and then nose), the privacy setting for all of schedule, note, e-mail, and incoming call may be enabled. Further, for example, after a particular period in which there is no conversation between the interacting electronic apparatus and the user, the privacy setting can be enabled (or disabled) for all of schedule, note, e-mail, and incoming call. For example, when the user cannot be recognized in face recognition performed by the interactive electronic apparatus, the privacy setting may be enabled (or disabled) for all of schedule, note, e-mail, and incoming call. For example, when the user presses a particular button such as a power button, the privacy setting may be enabled (or disabled) for all of schedule, note, e-mail, and incoming call. Functions as described above enable the user to quickly set the privacy setting as desired. For example, when someone approaches during a conversation while the privacy setting is disabled, the user can enable the privacy setting without being noticed by the person. For example, when someone left and the user can have privacy, the user can disable the privacy setting at once and set verbal output of necessary information. Here, before enabling (or disabling) the entire privacy setting, a confirmation screen may be displayed to the user. In the present embodiment, confirmation of the presence or absence of a stranger located in the vicinity is performed by the controller 32 by activating the camera 28 and searching for a face of a person in images (step S303 to step S305 of FIG. 6). Here, the controller 32 may determine the presence or absence of a stranger located in the vicinity by performing voice recognition (voiceprint recognition). The controller 32 may determine the presence or absence of a stranger located in the vicinity using a specific conversation between the interactive electronic apparatus and the user as described above. The controller 32 may determine the presence or absence of a stranger using a sequential touching of a registered image as described above.

In the first embodiment, the content modification operation is performed when the speech subjected to the speech operation is based on the schedule, note, e-mail, or incoming call. Here, the content modification operation may be performed on all speeches (including general dialogues) to be output in the speech operation. For example, when the controller 22 detects that the mobile terminal 11 is mounted on the charging stand 12 located at a place other than a particular place (e.g., the house of the user targeted for interaction) based on the location information of a GPS signal acquired from the charging stand 12, the controller 22 may perform the content modification operation on all speeches to be output. At this time, all of the personal information included in the speeches may be replaced by a predetermined or general phrase. For example, when the controller 22 detects that the mobile terminal 11 is mounted on the charging stand 12 located at a place other than the house of the user targeted for interaction, the controller 22 performs the content modification operation on all speeches to be output. In this case, for example, the controller 22 changes a general speech “It's Mr. B's birthday today” to “It's a friend's birthday.” By performing the content modification operation on the content of each speech to be output including general conversations, personal information of the user targeted for interaction can be more securely protected.

The network used herein includes, unless otherwise specified, the Internet, an ad hoc network, LAN (Local Area Network), WAN (Wide Area Network), MAN (Metropolitan Area Network), a cellular network, WWAN (Wireless Wide Area Network), WPAN (Wireless Personal Area Network), PSTN (Public Switched Phone Network), terrestrial wireless network (Terrestrial Wireless Network), other network, or any combination thereof. An element of the wireless network includes, for example, an access point (e.g., a Wi-Fi access point), a Femtocell, or the like. Further, a wireless communication apparatus may connected to a wireless network that uses Wi-Fi, Bluetooth, a cellular communication technology (e.g. CDMA (Code Division Multiple Access), TDMA (Time Division Multiple Access), FDMA (Frequency Division Multiple Access), OFDMA (Orthogonal Frequency Division Multiple Access), SC-FDMA (Single-Carrier Frequency Division Multiple Access)), or other wireless technologies and/or technical standards. The network can employ one or more technologies, such as UTMS (Universal Mobile Telecommunications System), LIE (Long Term Evolution), EV-DO (Evolution-Data Optimized or Evolution-Data), GSM® (Global System for Mobile communications, GSM is a registered trademark in Japan, other countries, or both), WiMAX (Worldwide Interoperability for Microwave Access), CDMA-2000 (Code Division Multiple Access-2000), or TD-SCDMA (Time Division Synchronous Code Division Multiple Access).

Circuit configurations of the communication interfaces 13 and 23 provide functionality by using various wireless communication network such as, for example, WWAN, WLAN, WPAN, or the like. WWAN may include CDMA network, TDMA network, FDMA network, OFDMA network, SC-FDMA network, or the like. CDMA network may implement one or more RAT (Radio Access Technology) such as CDMA2000, Wideband-CDMA (W-CDMA), or the like. CDMA2000 includes a standard such as IS-95, IS-2000, or IS-856. TDMA network may implement RAT such as GSM, D-AMPS (Digital Advanced Phone System), or the like. GSM and W-CDMA are described in documents issued by a consortium called 3rd Generation Partnership Project (3GPP). CDMA2000 is described in documents issued by a consortium called 3rd Generation Partnership Project 2 (3GPP2). WLAN may include IEEE802.11x network. WPAN may include Bluetooth network, IEEE802.15x, or other types of network. CDMA may be implemented as a wireless technology such as UTRA (Universal Terrestrial Radio Access) or CDMA2000. TDMA may be implemented by using a wireless technology such as GSM/GPRS (General Packet Radio Service)/EDGE (Enhanced Data Rates for GSM Evolution). OFDMA may be implemented by a wireless technology such as IEEE (Institute of Electrical and Electronics Engineers) 802.11 (Wi-Fi), IEEE802.16 (WiMAX), IEEE802.20, E-UTRA (Evolved UTRA), or the like. These technologies can be used for any combination of WWAN, WLAN and/or WPAN. Also, these technologies may be implemented to use UMB (Ultra Mobile Broadband) network, HRPD (High Rate Packet Data) network, CDMA20001X network, GSM, LTE (Long-Term Evolution), or the like.

The memories 21 and 31 described above may store an appropriate set of computer instructions such as program modules that are used to cause a processor to perform the techniques disclosed herein, and a data structure. A computer-readable medium includes electrical connection through one or more wires, a magnetic disk storage, a magnetic cassette, a magnetic tape, another magnetic or optical storage device (e.g., CD (Compact Disk), Laser Disc® (Laser Disc is a registered trademark in Japan, other countries, or both), DVD (Digital Versatile disc), Floppy Disk, or Blu-ray Disc), a portable computer disk, RAM (Random Access memory), ROM (Read-Only memory),

EPROM, EEPROM, a ROM such as a flash memory which is rewritable and programmable, other tangible storage media capable of storing information, or any combination thereof. The memory may be provided within and/or external to the processor/processing unit. As used herein, the term “memory” means any kind of a long-term storage, a short-term storage, a volatile memory, a nonvolatile memory, or other memories, and does not limit a type of a memory, the number of memories, and a type of a medium for storing.

Note that a system as disclosed herein includes various modules and/or units configured to perform a specific function, and these modules and units are schematically illustrated to briefly explain their functionalities and do not specify particular hardware and/or software. In that sense, these modules, units, and other components simply need to be hardware and/or software configured to substantially perform the specific functions described herein. Various functions of different components may be realized by any combination or subdivision of hardware and/or software, and each of the various functions may be used separately or in any combination. Further, an input/output device, an 110 device, or user interface configured as, and not limited to, a keyboard, a display, a touch screen, and a pointing device may be connected to the system directly or via an intermediate 110 controller. Thus, various aspects of the present disclosure may be realized in many different embodiments, all of which are included within the scope of the present disclosure.

### REFERENCE SIGNS LIST

10 communication system
11 mobile terminal
12 charging stand
13 communication interface
14 power receiving unit
15 battery
16 microphone
17 speaker
18 camera
19 display
20 input interface
21 memory
22 controller
23 communication interface
24 power supply unit
25 changing mechanism
26 microphone
27 speaker
28 camera
29 motion sensor
30 mount sensor
31 memory
32 controller

1. An interactive electronic apparatus comprising:
a controller configured to perform a content modification operation for modifying a content to be verbally output from a speaker, the content modification operation based on a privacy level corresponding to a person located in a vicinity of the interactive electronic apparatus.

2. The interactive electronic apparatus according to claim 1,
wherein the interactive electronic apparatus is a mobile terminal, and
the controller is configured to perform the content modification operation when the interactive electronic apparatus is mounted on a charging stand.

3. The interactive electronic apparatus according to claim 1,
wherein the person located in the vicinity of the interactive electronic apparatus is identified based on an image captured by a camera.

4. (canceled)

5. A method comprising:
modifying a content to be verbally output from a speaker, based on a privacy level corresponding to a person located in a vicinity of an interactive electronic apparatus.

6. (canceled)

7. An interactive electronic apparatus comprising:
a controller configured to perform a speech operation using a content corresponding to a specific level of a user targeted for interaction.

8. The interactive electronic apparatus according to claim 7, wherein the controller increases a degree of correspondence between the content subjected to the speech operation and the user targeted for interaction, as the specific level converges in a direction which specifies the user targeted for interaction.

9. The interactive electronic apparatus according to claim 7,
wherein the specific level is determined based on a detected voice in the vicinity.

10. The interactive electronic apparatus according to claim 7,
wherein the specific level is determined based on a captured image of the vicinity.

11. The interactive electronic apparatus according to claim 7,
wherein the interactive electronic apparatus is a mobile terminal, and
the controller performs a speech operation when the mobile terminal is mounted on a charging stand.

12. The interactive electronic apparatus according to claim 7,
wherein the interactive electronic apparatus is a charging stand, and
the controller performs a speech operation when a mobile terminal is mounted on the charging stand.

13. (canceled)

14. A method comprising:
determining a specific level of a user targeted for interaction; and
performing a speech operation using a content corresponding to the specific level.

15. (canceled)
